(19) United States
(12) Patent Application Publication
(10) Pub. No.: US 2026/0050141 A1
(43) Pub. Date: Feb. 19, 2026

(54) OPTICAL IMAGING SYSTEM

(71) Applicant: Samsung Electro-Mechanics Co., Ltd., Suwon-si (KR)

(72) Inventors: Dong Hyuk JANG, Suwon-si (KR); Min Hyuk IM, Suwon-si (KR); Ji Su LEE, Suwon-si (KR)

(73) Assignee: Samsung Electro-Mechanics Co., Ltd., Suwon-si (KR)

(21) Appl. No.: 19/259,314

(22) Filed: Jul. 3, 2025

(30) Foreign Application Priority Data
Aug. 13, 2024 (KR) 10-2024-0108632
Nov. 29, 2024 (KR) 10-2024-0175222

(51) Int. Cl. G02B 13/00; G02B 9/64

(52) U.S. Cl. CPC G02B 13/0045; G02B 9/64

(57) ABSTRACT

An optical imaging system includes a first lens having positive refractive power; a second lens having negative refractive power; a third lens having positive refractive power; a fourth lens, a fifth lens, a sixth lens, and a seventh lens each having refractive power, the first to seventh lenses are sequentially disposed from an object side. 0<f1/f3<0.4, 0.5<TTL/(2×IMG HT)<0.58, and 85.3°×(6.12/6.3228)≤FOV×(IMG HT/f)≤88.1°×(6.12/5.9978) are satisfied, where f1 is a focal length of the first lens, f3 is a focal length of the third lens, TTL is a distance on an optical axis from an object-side surface of the first lens to an imaging plane, IMG HT is half a diagonal length of the imaging plane, FOV is a field of view of the optical imaging system, and f is a total focal length of the optical imaging system.

### CROSS-REFERENCE TO RELATED APPLICATIONS

This application claims the benefit of priority to Korean Patent Application Nos. 10-2024-0108632 filed on Aug. 13, 2024, and 10-2024-0175222 filed on Nov. 29, 2024, in the Korean Intellectual Property Office, the entire disclosures of which are incorporated herein by reference for all purposes.

### BACKGROUND

### 1. Field

The present disclosure relates to an optical imaging system.

### 2. Description of the Background

Mobile devices may include cameras having an optical imaging system comprised of a plurality of lenses to enable video calls and image capturing.

Smaller mobile devices may include slimmer cameras with high resolution.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power; a second lens having negative refractive power; a third lens having positive refractive power; a fourth lens having refractive power; a fifth lens having refractive power; a sixth lens having refractive power; and a seventh lens having refractive power, sequentially disposed from an object side. The optical imaging system satisfies 0<f1/f3<0.4, 0.5<TTL/(2×IMG HT)<0.58, and 160°<FOV×(IMG HT/f)<180°, where f1 is a focal length of the first lens, f3 is a focal length of the third lens, TTL is a distance on an optical axis from an object-side surface of the first lens to an imaging plane, IMG HT is half a diagonal length of the imaging plane, FOV is a field of view of the optical imaging system, and f is a total focal length of the optical imaging system.

The optical imaging system may satisfy any one or any combination of any two or more of 25<v1−v2<45, 25<v1−v4<45, and 15<v1−v6<25, where v1 is an Abbe number of the first lens, v2 is an Abbe number of the second lens, v4 is an Abbe number of the fourth lens, and v6 is an Abbe number of the sixth lens.

The optical imaging system may satisfy 0<f1/f<1.4.

The optical imaging system may satisfy −10<f2/f<0, where f2 is a focal length of the second lens.

The optical imaging system may satisfy −0.6<f1/f2<0, where f2 is a focal length of the second lens.

The optical imaging system may satisfy 0<f3/f<10.

The optical imaging system may satisfy −13<f4/f<0, where f4 is a focal length of the fourth lens.

The optical imaging system may satisfy −15<f5/f<0, where f5 is a focal length of the fifth lens.

The optical imaging system may satisfy 0<f6/f<1.5, where f6 is a focal length of the sixth lens.

The optical imaging system may satisfy −0.95<f7/f<0, where f7 is a focal length of the seventh lens.

The optical imaging system may satisfy 1.0<TTL/f<1.3 and 0.15<BFL/f<0.3, where BFL is a distance along the optical axis from an image-side surface of the seventh lens to the imaging plane.

The optical imaging system may satisfy 0<D1/f<0.1, where D1 is a distance along the optical axis from an image-side surface of the first lens to an object-side surface of the second lens.

The optical imaging system may satisfy 1<Fno×TTL/(2×IMG HT))<1.1, where Fno is an F number of the optical imaging system.

Two or more of the first to seventh lenses may have a refractive index greater than 1.6 and negative refractive power.

Refractive indices of the fourth lens and the fifth lens may be greater than 1.6 and less than 1.7. The fourth lens and the fifth lens may each have negative refractive power.

Among the first to seventh lenses, an absolute value of a focal length of one of the fourth lens and the fifth lens is the greatest.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a diagram illustrating aberration characteristics of the optical imaging system illustrated in FIG. 1.

FIG. 3 is a configuration diagram of an optical imaging system according to a second embodiment of the present disclosure.

FIG. 4 is a diagram illustrating aberration characteristics of the optical imaging system illustrated in FIG. 3.

FIG. 5 is a configuration diagram of an optical imaging system according to a third embodiment of the present disclosure.

FIG. 6 is a diagram illustrating aberration characteristics of the optical imaging system illustrated in FIG. 5.

FIG. 7 is a configuration diagram of an optical imaging system according to a fourth embodiment of the present disclosure.

FIG. 8 is a diagram illustrating aberration characteristics of the optical imaging system illustrated in FIG. 7.

FIG. 9 is a configuration diagram of an optical imaging system according to a fifth embodiment of the present disclosure.

FIG. 10 is a diagram illustrating aberration characteristics of the optical imaging system illustrated in FIG. 9.

FIG. 11 is a configuration diagram of an optical imaging system according to a sixth embodiment of the present disclosure.

FIG. 12 is a diagram illustrating aberration characteristics of the optical imaging system illustrated in FIG. 11.

FIG. 13 is a configuration diagram of an optical imaging system according to a seventh embodiment of the present disclosure.

FIG. 14 is a diagram illustrating aberration characteristics of the optical imaging system illustrated in FIG. 13.

FIG. 15 is a configuration diagram of an optical imaging system according to an eighth embodiment of the present disclosure.

FIG. 16 is a diagram illustrating aberration characteristics of the optical imaging system illustrated in FIG. 15.

FIG. 17 is a configuration diagram of an optical imaging system according to a ninth embodiment of the present disclosure.

FIG. 18 is a diagram illustrating aberration characteristics of the optical imaging system illustrated in FIG. 17.

FIG. 19 is a configuration diagram of an optical imaging system according to a tenth embodiment of the present disclosure.

FIG. 20 is a diagram illustrating aberration characteristics of the optical imaging system illustrated in FIG. 19.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An imaging optical system according to an embodiment of the present disclosure includes seven lenses.

A first lens refers to a lens closest to an object side, and a seventh lens refers to a lens closest to an imaging plane (or an image sensor).

Additionally, in the present specification, values for a radius of curvature, a thickness, a distance, a focal length, or the like of a lens are all in mm, and a unit of a field-of-view (FOV) is degrees.

In addition, in the description of the shape of each lens, a shape in which one surface is convex means that a paraxial region of the one surface is convex, and a shape in which one surface is concave means that a paraxial region of the one surface is concave.

Thus, even if one surface of a lens is described as having a convex shape, an edge portion of the lens may be concave. Likewise, even if one surface of a lens is described as having a concave shape, an edge portion of the lens may be convex.

Meanwhile, the paraxial region refers to a very narrow region near an optical axis.

The imaging plane may refer to a virtual plane on which a focus is formed by the optical imaging system. Alternatively, the imaging plane may refer to one surface of the image sensor receiving light.

An optical imaging system according to an embodiment of the present disclosure includes at least seven lenses.

For example, an optical imaging system according to an embodiment of the present disclosure may include a first lens, a second lens, a third lens, a fourth lens, a fifth lens, a sixth lens, and a seventh lens, sequentially disposed from an object side. The first to seventh lenses may be spaced apart from each other, respectively, by a preset distance along an optical axis.

An optical imaging system according to an embodiment of the present disclosure may further include an image sensor for converting an incident image of a subject into an electrical signal.

Additionally, the optical imaging system may further include an infrared filter (hereinafter referred to as a ‘filter’) to block infrared rays. The filter is disposed between the seventh lens and the image sensor.

Additionally, the optical imaging system may further include a stop for controlling an amount of light.

The first to seventh lenses configuring an optical imaging system according to an embodiment of the present disclosure may be formed of a plastic material.

Additionally, at least one lens among the first to seventh lenses may have an aspherical surface. For example, the first to seventh lenses may each have at least one aspherical surface.

That is, at least one of an object-side surface and an image-side surface of the first to seventh lenses may be aspherical. In this case, the aspherical surfaces of the first to seventh lenses are expressed by the following Equation 1.

$$Z = \frac{c {Y}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} … \qquad Equation 1$$

In Equation 1, c is a curvature (reciprocal of a radius of curvature) of a lens, K is a conic constant, and Y represents a distance from certain point on an aspherical surface of the lens to an optical axis. In addition, the constants A˜H, J, and L˜P refer to aspheric coefficients. Moreover, Z (SAG) represents a distance in an optical axis direction between the certain point on the aspherical surface of the lens and a vertex of the aspherical surface.

An optical imaging system according to an embodiment of the present disclosure may satisfy at least one of the following conditional expressions.

In an embodiment, the optical imaging system may satisfy the condition 0<f1/f<1.4. In this case, f1 is a focal length of the first lens, and f is a total focal length of the optical imaging system. Therefore, the occurrence of aberration may be minimized by appropriately adjusting the refractive power of the first lens.

In an embodiment, the optical imaging system may satisfy the condition 25<v1−v2<45. In this case, v1 is an Abbe number of the first lens, and v2 is an Abbe number of the second lens. Therefore, chromatic aberration may be improved.

In an embodiment, the optical imaging system may satisfy the condition 25<v1−v4<45. In this case, v4 is an Abbe number of the fourth lens. Therefore, chromatic aberration may be improved.

In an embodiment, the optical imaging system may satisfy the condition 15<v1−v6<25. In this case, v6 is an Abbe number of the sixth lens. Therefore, chromatic aberration may be improved.

In an embodiment, the optical imaging system may satisfy the condition −10<f2/f<0. In this case, f2 is a focal length of the second lens. Therefore, the occurrence of aberration may be minimized by appropriately adjusting the refractive power of the second lens.

In an embodiment, the optical imaging system may satisfy the condition 0<f3/f<10. In this case, f3 is a focal length of the third lens. Therefore, the occurrence of aberration may be minimized by appropriately adjusting the refractive power of the third lens.

In an embodiment, the optical imaging system may satisfy the condition −13<f4/f<0. In this case, f4 is a focal length of the fourth lens. Therefore, the occurrence of aberration may be minimized by appropriately adjusting the refractive power of the fourth lens.

In an embodiment, the optical imaging system may satisfy the condition −15<f5/f<0. In this case, f5 is a focal length of the fifth lens. Therefore, the occurrence of aberration may be minimized by appropriately adjusting the refractive power of the fifth lens.

In an embodiment, the optical imaging system may satisfy the condition 0<f6/f<1.5. In this case, f6 is a focal length of the sixth lens. Therefore, the occurrence of aberration may be minimized by appropriately adjusting the refractive power of the sixth lens.

In an embodiment, the optical imaging system may satisfy the condition −0.95<f7/f<0. In this case, f7 is a focal length of the seventh lens. Therefore, an image resolution may be improved and a field curvature phenomenon may be reduced.

In an embodiment, the optical imaging system may satisfy the condition 1.0<TTL/f<1.3. In this case, TTL is a distance on an optical axis from an object-side surface of the first lens to an imaging plane. Therefore, the optical imaging system may have an appropriate field of view and total track length.

In an embodiment, the optical imaging system may satisfy the condition −0.6<f1/f2<0. Therefore, the resolution may be improved by appropriately adjusting the refractive power of the first lens and the second lens.

In an embodiment, the optical imaging system may satisfy the condition 0<f1/f3<0.4. Therefore, the resolution may be improved by appropriately adjusting the refractive power of the first lens and the third lens.

In an embodiment, the optical imaging system may satisfy the condition 0.15<BFL/f<0.3. In this case, BFL is a distance along the optical axis from an image-side surface of the seventh lens to an imaging plane. Therefore, the imaging optical system may be miniaturized.

In an embodiment, the optical imaging system may satisfy the condition 0<D1/f<0.1. In this case, D1 is a distance on an optical axis from an image-side surface of the first lens to an object-side surface of the second lens. Therefore, chromatic aberration may be improved.

In an embodiment, the optical imaging system may satisfy the condition 0.5<TTL/(2×IMG HT)<0.58. In this case, IMG HT is half the diagonal length of the imaging plane. Therefore, the optical imaging system may be miniaturized.

In an embodiment, the optical imaging system may satisfy the condition 160°<FOV×(IMG HT/f)<180°. FOV is a field of view of the optical imaging system. Therefore, the optical imaging system may have an appropriate field of view and total track length, and the occurrence of aberrations may be minimized.

In an embodiment, the optical imaging system may satisfy the condition 1<Fno×(TTL/(2×IMG HT))<1.1. In this case, it may refer to an F-number of the optical imaging system. Therefore, the brightness of the optical imaging system may be improved (i.e., capable of capturing bright images) and the optical imaging system may be miniaturized.

The first lens may have positive refractive power. Additionally, the first lens may have a meniscus shape convex toward the object side. For example, an object-side surface of the first lens may be convex in a paraxial region, and an image-side surface of the first lens may be concave in the paraxial region.

The second lens may have negative refractive power. Additionally, the second lens may have a meniscus shape convex toward the object side. For example, an object-side surface of the second lens may be convex in a paraxial region, and an image-side surface of the second lens may be concave in the paraxial region.

The third lens may have positive refractive power. Additionally, the third lens may have a shape in which both surfaces thereof are convex. For example, an object-side surface and an image-side surface of the third lens may be convex in a paraxial region. Alternatively, the third lens may have a meniscus shape convex toward an object side. For example, the object-side surface of the third lens may be convex in the paraxial region, and the image-side surface of the third lens may be concave in the paraxial region.

The fourth lens may have negative refractive power. Additionally, the third lens may have a shape in which both surfaces thereof are concave. For example, an object-side surface and an image-side surface of the fourth lens may be concave in a paraxial region. Alternatively, the fourth lens may have a meniscus shape convex toward an image side. For example, an object-side surface of the fourth lens may be concave in a paraxial region, and an image-side surface of the fourth lens may be convex in the paraxial region. Alternatively, the fourth lens may have a meniscus shape convex toward the object side. For example, the object-side surface of the fourth lens may be convex in the paraxial region, and the image-side surface of the fourth lens may be concave in the paraxial region.

The fifth lens may have negative refractive power. Additionally, the fifth lens may have a meniscus shape convex toward the object side. For example, an object-side surface of the fifth lens may be convex in a paraxial region, and an image-side surface of the fifth lens may be concave in the paraxial region.

The sixth lens may have positive refractive power. Additionally, the sixth lens may have a meniscus shape convex toward the object side. For example, an object-side surface of the sixth lens may be convex in a paraxial region, and an image-side surface of the sixth lens may be concave in the paraxial region. Alternatively, the sixth lens may have a shape in which both surfaces thereof are convex. For example, the object-side surface and the image-side surface of the sixth lens may be convex in the paraxial region.

The seventh lens may have negative refractive power. Additionally, the seventh lens may have a meniscus shape convex toward the object side. For example, an object-side surface of the seventh lens may be convex in a paraxial region, and an image-side surface of the seventh lens may be concave in the paraxial region.

Additionally, more than one of the sixth lens and the seventh lens may have at least one inflection point formed on at least one of the object-side surface or the image-side surface. For example, the object-side surface of the sixth lens may be convex in a paraxial region and concave in a portion other than the paraxial region. The image-side surface of the seventh lens may be concave in a paraxial region and convex in a portion other than the paraxial region.

The optical imaging system may be configured to have a field of view greater than 80°. In an embodiment, the field of view of the optical imaging system may be less than 90°.

In an embodiment, at least two of the first to seventh lenses may have a refractive index greater than 1.6. All of the lenses having a refractive index greater than 1.6 may have negative refractive power.

In an embodiment, at least two of the first to seventh lenses may have a refractive index of 1.67 or greater. For example, the refractive index of the second lens and the refractive index of the fourth lens may be greater than or equal to 1.67 and less than 1.7, respectively.

In an embodiment, at least two lenses having a refractive index greater than 1.6 may be disposed adjacently. For example, the fourth and fifth lenses disposed adjacently may have a refractive index greater than 1.6 and less than 1.7, respectively.

In addition, among the first to seventh lenses, an absolute value of the focal length of either the fourth lens or the fifth lens may be configured to be the greatest.

The first to seventh lenses have a predetermined Abbe number, respectively. At least three lenses among the first to seventh lenses may have an Abbe number less than 26 and greater than 15. Also, all lenses having an Abbe number less than 26 may have negative refractive power.

In an embodiment, the number of lenses having an Abbe number less than 26 may be three.

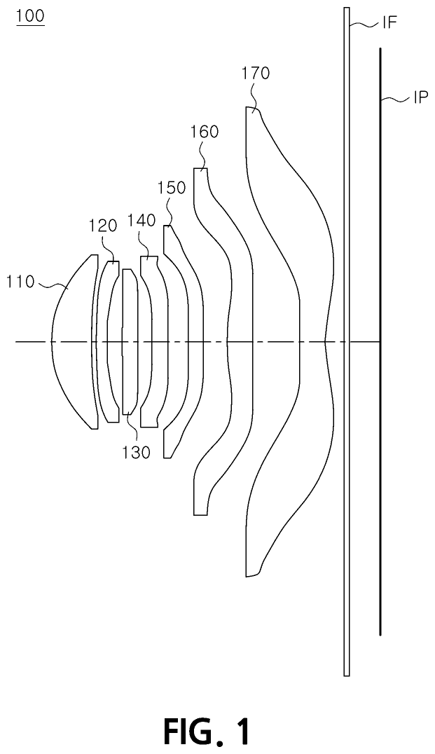

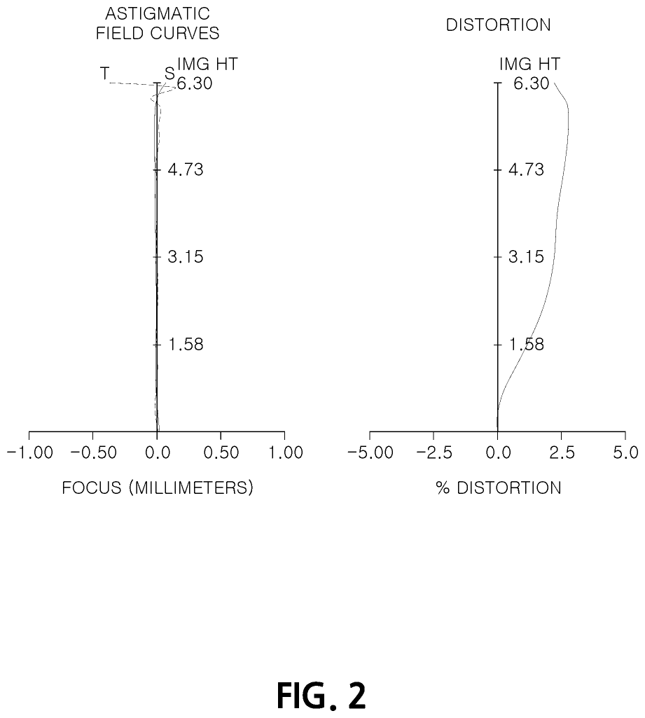

An optical imaging system 100 according to a first embodiment of the present disclosure will be described with reference to FIGS. 1 and 2.

The optical imaging system 100 according to the first embodiment of the present disclosure may include a first lens 110, a second lens 120, a third lens 130, a fourth lens 140, a fifth lens 150, a sixth lens 160, and a seventh lens 170, and may further include a filter IF and an image sensor.

The optical imaging system 100 according to the first embodiment of the present disclosure may form a focus on an imaging plane IP.

Lens characteristics of each lens (a radius of curvature, a thickness of a lens or a distance between lenses, a refractive index, and an Abbe number) are illustrated in Table 1.

TABLE 1

| Surface | | Curvature | Thickness or | Refractive | Abbe |
|---|---|---|---|---|---|
| No. | | Radius | Distance | Index | No. |
| S0 | Stop | Infinity | −0.724 | | |
| S1 | 1st Lens | 2.287 | 0.856 | 1.544 | 56.1 |
| S2 | | 11.105 | 0.100 | | |
| S3 | 2nd Lens | 15.053 | 0.230 | 1.671 | 19.2 |
| S4 | | 5.509 | 0.332 | | |
| S5 | 3rd Lens | 26.322 | 0.355 | 1.544 | 56.1 |
| S6 | | −67.369 | 0.269 | | |
| S7 | 4th Lens | −62.139 | 0.357 | 1.671 | 19.2 |
| S8 | | 50.981 | 0.450 | | |
| S9 | 5th Lens | 30.395 | 0.310 | 1.614 | 25.9 |
| S10 | | 14.258 | 0.502 | | |
| S11 | 6th Lens | 4.529 | 0.562 | 1.567 | 38.0 |
| S12 | | 114.664 | 1.004 | | |
| S13 | 7th Lens | 10.158 | 0.543 | 1.535 | 56.1 |
| S14 | | 2.197 | 0.400 | | |
| S15 | Filter | Infinity | 0.110 | 1.518 | 64.2 |
| S16 | | Infinity | 0.641 | | |
| S17 | Imaging | Infinity | | | |
| | plane | | | | |

In the first embodiment of the present disclosure, the first lens 110 may have positive refractive power, an object-side surface of the first lens 110 may be convex in a paraxial region, and an image-side surface of the first lens 110 may be concave in the paraxial region.

The second lens 120 may have negative refractive power, an object-side surface of the second lens 120 may be convex in a paraxial region, and an image-side surface of the second lens 120 may be concave in the paraxial region.

The third lens 130 may have positive refractive power, and an object-side surface and an image-side surface of the third lens 130 may be convex in a paraxial region.

The fourth lens 140 may have negative refractive power, and an object-side surface and an image-side surface of the fourth lens 140 may be concave in a paraxial region.

The fifth lens 150 may have negative refractive power, an object-side surface of the fifth lens 150 may be convex in a paraxial region, and an image-side surface of the fifth lens 150 may be concave in the paraxial region.

The sixth lens 160 may have positive refractive power, an object-side surface of the sixth lens 160 may be convex in a paraxial region, and an image-side surface of the sixth lens 160 may be concave in the paraxial region.

The seventh lens 170 may have negative refractive power, an object-side surface of the seventh lens 170 may be convex in a paraxial region, and an image-side surface of the seventh lens 170 may be concave in the paraxial region.

Additionally, one or more of the sixth lens 160 and the seventh lens 170 may have at least one inflection point formed on at least one of the object-side surface and the image-side surface.

Meanwhile, each surface of the first lens 110 to the seventh lens 170 may have an aspherical coefficient, as illustrated in Table 2. For example, both the object-side surface and the image-side surface of the first lens 110 to the seventh lens 170 may be aspherical.

TABLE 2

| | S1 | S2 | S3 | S4 | S5 | S6 | S7 |
|---|---|---|---|---|---|---|---|
| Conic constant K | −4.958E−01 | 2.407E+01 | 8.788E+01 | 3.659E+00 | 7.302E+00 | −9.900E+01 | −9.637E+01 |
| 4th coefficient A | 6.966E−03 | 3.966E−03 | 9.595E−03 | 2.845E−03 | −1.628E−02 | −2.794E−02 | −5.204E−02 |
| 6th coefficient B | −1.187E−02 | 2.895E−03 | −3.046E−02 | 3.428E−02 | −3.139E−03 | 3.382E−02 | 3.235E−02 |
| 8th coefficient C | 6.680E−02 | −4.728E−02 | 1.715E−01 | −3.250E−01 | −6.332E−03 | −2.112E−01 | −1.696E−01 |
| 10th coefficient D | −2.095E−01 | 2.189E−01 | −6.555E−01 | 1.720E+00 | 2.271E−01 | 9.823E−01 | 6.987E−01 |
| 12th coefficient E | 4.368E−01 | −6.005E−01 | 1.698E+00 | 5.783E+00 | 1.323E+00 | −3.157E+00 | 2.134E+00 |
| 14th coefficient F | −6.316E−01 | 1.097E+00 | −3.047E+00 | 1.323E+01 | 4.129E+00 | 7.131E+00 | 4.642E+00 |
| 16th coefficient G | 6.501E−01 | −1.398E+00 | 3.871E+00 | −2.128E+01 | 8.130E+00 | −1.146E+01 | −7.198E+00 |
| 18th coefficient H | −4.825E−01 | 1.268E+00 | −3.527E+00 | 2.449E+01 | 1.076E+01 | 1.323E+01 | 8.004E+00 |
| 20th coefficient J | 2.588E−01 | −8.232E−01 | 2.309E+00 | −2.023E+01 | 9.828E+00 | −1.099E+01 | −6.377E+00 |
| 22nd coefficient L | −9.930E−02 | 3.795E−01 | −1.077E+00 | 1.189E+01 | 6.213E+00 | 6.496E+00 | 3.600E+00 |
| 24th coefficient M | 2.657E−02 | −1.212E−01 | 3.491E−01 | −4.847E+00 | −2.670E+00 | −2.668E+00 | −1.401E+00 |
| 26th coefficient N | −4.706E−03 | 2.549E−02 | −7.464E−02 | 1.302E+00 | 7.446E−01 | 7.227E−01 | 3.564E−01 |
| 28th coefficient O | 4.957E−04 | −3.173E−03 | 9.465E−03 | −2.071E−01 | −1.213E−01 | −1.161E−01 | −5.308E−02 |
| 30th coefficient P | −2.350E−05 | 1.770E−04 | −5.391E−04 | 1.476E−02 | 8.763E−03 | 8.365E−03 | 3.493E−03 |

| | S8 | S9 | S10 | S11 | S12 | S13 | S14 |
|---|---|---|---|---|---|---|---|
| Conic constant K | 5.402E+01 | 1.329E+01 | −2.725E+01 | −1.487E+01 | −9.900E+01 | 2.675E+00 | −8.104E+00 |
| 4th coefficient A | −4.506E−02 | −6.812E−02 | −1.050E−01 | −1.002E−02 | 6.578E−03 | −1.249E−01 | −6.044E−02 |
| 6th coefficient B | 3.877E−02 | −6.541E−02 | 5.408E−02 | −3.074E−03 | −2.759E−03 | 4.962E−02 | 2.267E−02 |
| 8th coefficient C | −1.685E−01 | 4.252E−01 | −3.386E−02 | −9.686E−03 | −5.770E−03 | −1.662E−02 | −6.874E−03 |
| 10th coefficient D | 5.574E−01 | −1.148E+00 | 2.082E−02 | 1.513E−02 | 5.831E−03 | 4.770E−03 | 1.585E−03 |
| 12th coefficient E | −1.276E+00 | 1.991E+00 | −9.903E−03 | −1.286E−02 | −3.316E−03 | −1.061E−03 | −2.702E−04 |
| 14th coefficient F | 2.021E+00 | −2.401E+00 | 1.994E−03 | 7.100E−03 | 1.300E−03 | 1.752E−04 | 3.341E−05 |
| 16th coefficient G | −2.264E+00 | 2.070E+00 | 1.078E−03 | −2.677E−03 | −3.661E−04 | −2.128E−05 | −2.949E−06 |
| 18th coefficient H | 1.821E+00 | 1.291E+00 | −1.110E−03 | 6.999E−04 | 7.454E−05 | 1.902E−06 | 1.820E−07 |
| 20th coefficient J | −1.056E+00 | 5.826E−01 | 4.891E−04 | −1.273E−04 | −1.090E−05 | −1.245E−07 | −7.516E−09 |
| 22nd coefficient L | 4.376E−01 | −1.883E−01 | −1.312E−04 | 1.600E−05 | 1.130E−06 | 5.897E−09 | 1.838E−10 |
| 24th coefficient M | −1.263E−01 | 4.239E−02 | 2.221E−05 | −1.363E−06 | −8.091E−08 | −1.965E−10 | −1.367E−12 |
| 26th coefficient N | 2.410E−02 | −6.303E−03 | −2.286E−06 | 7.506E−08 | 3.810E−09 | 4.368E−12 | −5.861E−14 |
| 28th coefficient O | −2.728E−03 | 5.557E−04 | 1.284E−07 | −2.415E−09 | −1.063E−10 | −5.810E−14 | 1.803E−15 |
| 30th coefficient P | 1.384E−04 | −2.197E−05 | −2.934E−09 | 3.448E−11 | 1.332E−12 | 3.495E−16 | −1.636E−17 |

Additionally, the optical imaging system configured as described above may have aberration characteristics as illustrated in FIG. 2.

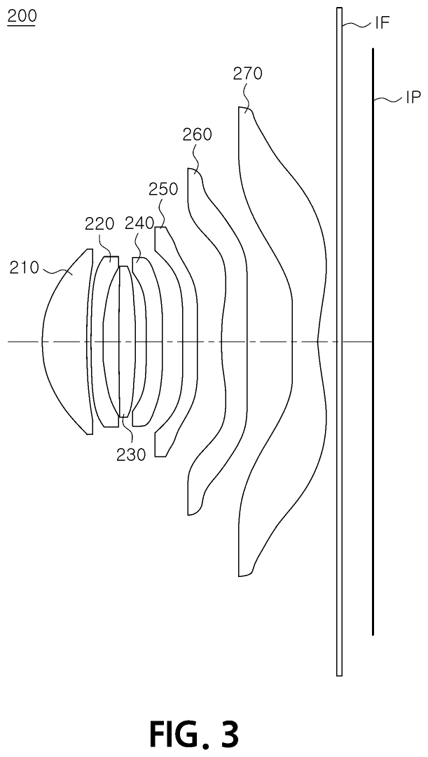

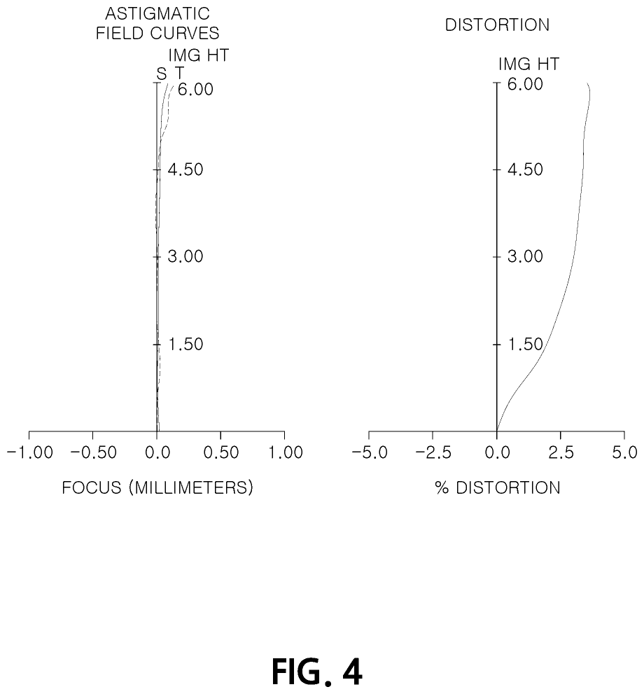

An optical imaging system 200 according to a second embodiment of the present disclosure will be described with reference to FIGS. 3 and 4.

The optical imaging system 200 according to the second embodiment of the present disclosure may include a first lens 210, a second lens 220, a third lens 230, a fourth lens 240, a fifth lens 250, a sixth lens 260, and a seventh lens 270, and may further include a filter IF and an image sensor.

The optical imaging system 200 according to the second embodiment of the present disclosure may form a focus on an imaging plane IP.

Lens characteristics of each lens (a radius of curvature, a thickness of a lens or a distance between lenses, a refractive index, and an Abbe number) are illustrated in Table 3.

TABLE 3

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.297 | 0.933 | 1.544 | 56.1 |
| S2 | | 10.906 | 0.100 | | |
| S3 | 2nd Lens | 15.261 | 0.260 | 1.671 | 19.2 |
| S4 | | 5.641 | 0.334 | | |
| S5 | 3rd Lens | 30.239 | 0.342 | 1.544 | 56.1 |
| S6 | | −93.952 | 0.240 | | |
| S7 | 4th Lens | −46.184 | 0.330 | 1.687 | 18.3 |
| S8 | | 93.294 | 0.450 | | |
| S9 | 5th Lens | 31.965 | 0.310 | 1.614 | 25.9 |
| S10 | | 16.251 | 0.511 | | |
| S11 | 6th Lens | 4.231 | 0.562 | 1.567 | 38.0 |
| S12 | | 37.155 | 0.948 | | |
| S13 | 7th Lens | 11.597 | 0.592 | 1.535 | 56.1 |
| S14 | | 2.275 | 0.400 | | |
| S15 | Filter | Infinity | 0.110 | 1.518 | 64.2 |
| S16 | | Infinity | 0.597 | | |
| S17 | Imaging | Infinity | | | |
| | plane | | | | |

In the second embodiment of the present disclosure, the first lens 210 may have positive refractive power, an object-side surface of the first lens 210 may be convex in a paraxial region, and an image-side surface of the first lens 210 may be concave in the paraxial region.

The second lens 220 may have negative refractive power, an object-side surface of the second lens 220 may be convex in a paraxial region, and an image-side surface of the second lens 220 may be concave in the paraxial region.

The third lens 230 may have positive refractive power, and an object-side surface and an image-side surface of the third lens 230 may be convex in a paraxial region.

The fourth lens 240 may have negative refractive power, and an object-side surface and an image-side surface of the fourth lens 240 may be concave in a paraxial region.

The fifth lens 250 may have negative refractive power, an object-side surface of the fifth lens 250 may be convex in a paraxial region, and an image-side surface of the fifth lens 250 may be concave in the paraxial region.

The sixth lens 260 may have positive refractive power, and an object-side surface of the sixth lens 260 may be convex in a paraxial region, and an image-side surface of the sixth lens 260 may be concave in the paraxial region.

The seventh lens 270 may have negative refractive power, an object-side surface of the seventh lens 270 may be convex in paraxial region, and an image-side surface of the seventh lens 270 may be concave in the paraxial region.

Additionally, one or more of the sixth lens 260 and the seventh lens 270 may have at least one inflection point formed on at least one of the object-side surface or the image-side surface.

Meanwhile, each surface of the first lens 210 to the seventh lens 270 may have an aspherical coefficient, as illustrated in Table 4. For example, both the object-side surface and the image-side surface of the first lens 210 to the seventh lens 270 may be aspherical.

TABLE 4

| | S1 | S2 | S3 | S4 | S5 | S6 | S7 |
|---|---|---|---|---|---|---|---|
| Conic constant K | −4.726E−01 | 9.180E+00 | 8.134E+01 | 4.732E+00 | 2.933E+01 | 4.927E+01 | 6.494E+01 |
| 4th coefficient A | 1.479E−02 | −1.539E−03 | 5.523E−03 | 8.839E−04 | −4.535E−03 | −3.888E−02 | −5.319E−02 |
| 6th coefficient B | −6.258E−02 | 1.770E−02 | −1.705E−02 | 6.811E−02 | −8.915E−02 | 1.778E−01 | 2.424E−02 |
| 8th coefficient C | 2.458E−01 | −7.995E−02 | 1.156E−01 | −4.959E−01 | 4.829E−01 | −1.108E+00 | −1.901E−01 |
| 10th coefficient D | −6.160E−01 | 2.199E−01 | −4.668E−01 | 2.243E+00 | −1.528E+00 | 4.549E+00 | 1.117E+00 |
| 12th coefficient E | 1.057E+00 | −3.910E−01 | 1.230E+00 | −6.734E+00 | 2.908E+00 | −1.283E+01 | −4.124E+00 |
| 14th coefficient F | −1.282E+00 | 4.710E−01 | −2.198E+00 | 1.407E+01 | −3.031E+00 | 2.570E+01 | 9.935E+00 |
| 16th coefficient G | 1.123E+00 | −3.941E−01 | 2.740E+00 | −2.098E+01 | 5.785E−01 | −3.726E+01 | −1.639E+01 |
| 18th coefficient H | −7.167E−01 | 2.305E−01 | −2.426E+00 | 2.261E+01 | 3.059E+00 | 3.943E+01 | 1.906E+01 |
| 20th coefficient J | 3.335E−01 | −9.316E−02 | 1.533E+00 | −1.764E+01 | −4.874E+00 | −3.042E+01 | −1.579E+01 |
| 22nd coefficient L | −1.119E−01 | 2.510E−02 | −6.868E−01 | 9.855E+00 | 3.926E+00 | 1.690E+01 | 9.270E+00 |
| 24th coefficient M | 2.632E−02 | −4.133E−03 | 2.129E−01 | −3.838E+00 | −1.936E+00 | −6.577E+00 | −3.770E+00 |
| 26th coefficient N | −4.120E−03 | 3.202E−04 | −4.339E−02 | 9.888E−01 | 5.900E−01 | 1.700E+00 | 1.010E+00 |
| 28th coefficient O | 3.854E−04 | 4.975E−06 | 5.230E−03 | −1.513E−01 | −1.025E−01 | −2.618E−01 | −1.601E−01 |
| 30th coefficient P | −1.629E−05 | −1.852E−06 | −2.824E−04 | 1.039E−02 | 7.783E−03 | 1.816E−02 | 1.138E−02 |
| | S8 | S9 | S10 | S11 | S12 | S13 | S14 |
| Conic constant K | 9.900E+01 | 1.516E+01 | −1.355E+01 | −1.736E+01 | −9.900E+01 | 4.080E+00 | −6.967E+00 |
| 4th coefficient A | −4.675E−02 | −1.038E−01 | −1.100E−01 | −1.175E−02 | 1.483E−03 | −1.247E−01 | −6.898E−02 |
| 6th coefficient B | −7.205E−03 | 1.380E−01 | 4.962E−02 | −3.773E−03 | −1.631E−02 | 4.513E−02 | 2.776E−02 |
| 8th coefficient C | 1.687E−01 | −3.445E−01 | −5.222E−03 | −4.218E−03 | 1.822E−02 | −1.267E−02 | −8.981E−03 |
| 10th coefficient D | −7.453E−01 | 7.629E−01 | −2.519E−02 | 8.623E−03 | −1.451E−02 | 2.965E−03 | 2.256E−03 |
| 12th coefficient E | 1.909E+00 | −1.222E+00 | 2.848E−02 | −8.187E−03 | 7.715E−03 | −5.105E−04 | −4.353E−04 |
| 14th coefficient F | −3.272E+00 | 1.378E+00 | −1.492E−02 | 4.753E−03 | −2.828E−03 | 5.861E−05 | 6.447E−05 |
| 16th coefficient G | 3.933E+00 | −1.104E+00 | 3.032E−03 | −1.818E−03 | 7.361E−04 | −3.969E−06 | −7.357E−06 |
| 18th coefficient H | −3.386E+00 | 6.356E−01 | 9.908E−04 | 4.720E−04 | −1.383E−04 | 8.065E−08 | 6.460E−07 |
| 20th coefficient J | 2.099E+00 | −2.627E−01 | −9.133E−04 | −8.411E−05 | 1.885E−05 | 1.176E−08 | −4.315E−08 |
| 22nd coefficient L | −9.298E−01 | 7.718E−02 | 3.156E−04 | 1.028E−05 | −1.843E−06 | −1.314E−09 | 2.142E−09 |
| 24th coefficient M | 2.870E−01 | −1.569E−02 | −6.391E−05 | −8.473E−07 | 1.259E−07 | 6.732E−11 | −7.602E−11 |
| 26th coefficient N | −5.864E−02 | 2.096E−03 | 7.948E−06 | 4.503E−08 | −5.694E−09 | −1.985E−12 | 1.812E−12 |
| 28th coefficient O | 7.132E−03 | −1.649E−04 | −5.661E−07 | −1.394E−09 | 1.528E−10 | 3.251E−14 | −2.587E−14 |
| 30th coefficient P | −3.908E−04 | 5.773E−06 | 1.777E−08 | 1.913E−11 | −1.838E−12 | −2.304E−16 | 1.665E−16 |

Additionally, the optical imaging system configured as described above may have aberration characteristics as illustrated in FIG. 4.

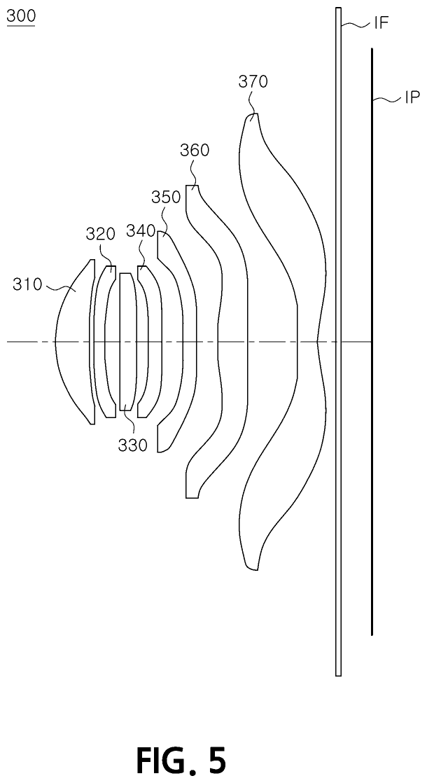

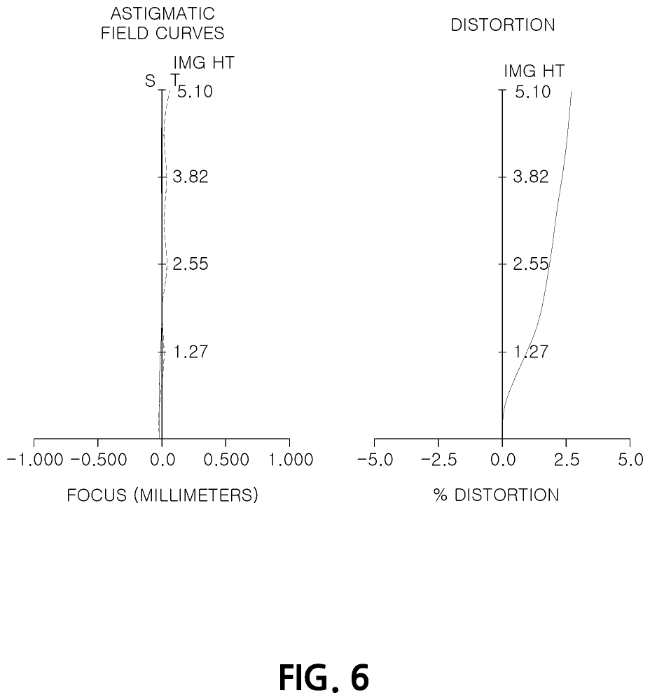

An optical imaging system 300 according to a third embodiment of the present disclosure will be described with reference to FIGS. 5 and 6.

The optical imaging system 300 according to the third embodiment of the present disclosure may include a first lens 310, a second lens 320, a third lens 330, a fourth lens 340, a fifth lens 350, a sixth lens 360, and a seventh lens 370, and may further include a filter IF and an image sensor.

The optical imaging system 300 according to the third embodiment of the present disclosure may form a focus on an imaging plane IP.

Lens characteristics of each lens (a radius of curvature, a thickness of a lens or a distance between lenses, a refractive index, and an Abbe number) are illustrated in Table 5.

TABLE 5

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.216 | 0.727 | 1.544 | 56.1 |
| S2 | | 7.937 | 0.110 | | |
| S3 | 2nd Lens | 10.164 | 0.230 | 1.680 | 18.2 |
| S4 | | 5.526 | 0.341 | | |
| S5 | 3rd Lens | 42.904 | 0.367 | 1.544 | 56.1 |
| S6 | | −24.376 | 0.240 | | |
| S7 | 4th Lens | −24.507 | 0.300 | 1.680 | 18.2 |
| S8 | | −439.360 | 0.450 | | |
| S9 | 5th Lens | 92.616 | 0.300 | 1.614 | 25.9 |
| S10 | | 13.080 | 0.460 | | |
| S11 | 6th Lens | 4.136 | 0.657 | 1.567 | 38.0 |
| S12 | | 254.065 | 1.075 | | |
| S13 | 7th Lens | 7.015 | 0.450 | 1.535 | 56.1 |
| S14 | | 1.917 | 0.400 | | |
| S15 | Filter | Infinity | 0.110 | 1.518 | 64.2 |
| S16 | | Infinity | 0.573 | | |
| S17 | Imaging | Infinity | | | |
| | plane | | | | |

In the third embodiment of the present disclosure, the first lens 310 may have positive refractive power, an object-side surface of the first lens 310 may be convex in a paraxial region, and an image-side surface of the first lens 310 may be concave in the paraxial region.

The second lens 320 may have negative refractive power, an object-side surface of the second lens 320 may be convex in a paraxial region, and an image-side surface of the second lens 320 may be concave in the paraxial region.

The third lens 330 may have positive refractive power, and an object-side surface and an image-side surface of the third lens 330 may be convex in a paraxial region.

The fourth lens 340 may have negative refractive power, an object-side surface of the fourth lens 340 may be concave in a paraxial region, and an image-side surface of the fourth lens 340 may be convex in the paraxial region.

The fifth lens 350 may have negative refractive power, an object-side surface of the fifth lens 350 may be convex in a paraxial region, and an image-side surface of the fifth lens 350 may be concave in the paraxial region.

The sixth lens 360 may have positive refractive power, an object-side surface of the sixth lens 360 may be convex in a paraxial region, and an image-side surface of the sixth lens 360 may be concave in the paraxial region.

The seventh lens 370 may have negative refractive power, an object-side surface of the seventh lens 370 may be convex in a paraxial region, and an image-side surface of the seventh lens 370 may be concave in the paraxial region.

Additionally, one or more of the sixth lens 360 and the seventh lens 370 may have at least one inflection point formed on at least one of the object-side surface or the image-side surface.

Meanwhile, each surface of the first lens 310 to the seventh lens 370 may have an aspherical coefficient, as illustrated in Table 6. For example, both the object-side surface and the image-side surface of the first lens 310 to the seventh lens 370 may be aspherical.

TABLE 6

| | S1 | S2 | S3 | S4 | S5 | S6 | S7 |
|---|---|---|---|---|---|---|---|
| Conic constant K | −5.737E−01 | 7.918E+00 | 4.127E+01 | 3.687E+00 | 0.000E+00 | 1.565E+01 | 0.000E+00 |
| 4th coefficient A | 3.708E−03 | −1.219E−03 | 4.892E−03 | 1.307E−02 | −2.517E−02 | −2.125E−02 | −5.917E−02 |
| 6th coefficient B | 1.737E−02 | 2.263E−02 | −8.344E−03 | −9.324E−02 | 1.794E−01 | −3.959E−03 | 7.097E−02 |
| 8th coefficient C | −4.618E−02 | −1.641E−01 | −9.611E−02 | 6.627E−01 | −1.491E+00 | −1.274E−01 | −4.061E−01 |
| 10th coefficient D | 8.613E−02 | 5.907E−01 | 7.472E−01 | −3.025E+00 | 7.715E+00 | 1.590E+00 | 1.252E+00 |
| 12th coefficient E | −9.622E−02 | −1.330E+00 | −2.608E+00 | 9.361E+00 | −2.646E+01 | −8.415E+00 | −1.769E+00 |
| 14th coefficient F | 3.394E−02 | 2.073E+00 | 5.630E+00 | −2.020E+01 | 6.261E+01 | 2.620E+01 | −1.225E+00 |
| 16th coefficient G | 7.661E−02 | −2.361E+00 | −8.234E+00 | 3.101E+01 | −1.048E+02 | −5.336E+01 | 1.034E+01 |
| 18th coefficient H | −1.484E−01 | 2.013E+00 | 8.479E+00 | −3.423E+01 | 1.257E+02 | 7.462E+01 | −2.160E+01 |
| 20th coefficient J | 1.350E−01 | −1.288E+00 | −6.230E+00 | 2.722E+01 | −1.085E+02 | −7.304E+01 | 2.609E+01 |
| 22nd coefficient L | −7.590E−02 | 6.096E−01 | 3.252E+00 | −1.543E+01 | 6.667E+01 | 5.006E+01 | −2.040E+01 |
| 24th coefficient M | 2.760E−02 | −2.063E−01 | −1.179E+00 | 6.086E+00 | −2.846E+01 | −2.356E+01 | 1.052E+01 |
| 26th coefficient N | −6.348E−03 | 4.699E−02 | 2.822E−01 | −1.586E+00 | 8.011E+00 | 7.250E+00 | −3.465E+00 |
| 28th coefficient O | 8.420E−04 | −6.431E−03 | −4.010E−02 | 2.456E−01 | −1.336E+00 | −1.315E+00 | 6.625E−01 |
| 30th coefficient P | −4.918E−05 | 3.983E−04 | 2.562E−03 | −1.714E−02 | 9.990E−02 | 1.065E−01 | −5.602E−02 |
| | S8 | S9 | S10 | S11 | S12 | S13 | S14 |
| Conic constant K | 0.000E+00 | 0.000E+00 | −3.576E+01 | −1.605E+01 | 8.483E+01 | 1.134E+00 | −7.253E+00 |
| 4th coefficient A | −4.631E−02 | −1.117E−01 | −1.416E−01 | −9.156E−03 | 6.485E−03 | −1.622E−01 | −7.956E−02 |
| 6th coefficient B | −1.049E−02 | 1.638E−01 | 1.545E−01 | −2.620E−02 | −6.359E−03 | 7.397E−02 | 3.629E−02 |
| 8th coefficient C | 1.933E−01 | −4.495E−01 | −2.778E−01 | 4.410E−02 | 1.025E−03 | −2.699E−02 | −1.321E−02 |
| 10th coefficient D | −9.361E−01 | 1.167E+00 | 4.719E−01 | −5.344E−02 | −1.386E−03 | 7.553E−03 | 3.632E−03 |
| 12th coefficient E | 2.697E+00 | −2.211E+00 | −5.847E−01 | 4.257E−02 | 1.191E−03 | −1.528E−03 | −7.502E−04 |
| 14th coefficient F | −5.304E+00 | 2.978E+00 | 5.109E−01 | −2.308E−02 | −4.745E−04 | 2.214E−04 | 1.170E−04 |
| 16th coefficient G | 7.405E+00 | −2.890E+00 | −3.176E−01 | 8.771E−03 | 9.066E−05 | −2.316E−05 | −1.379E−05 |
| 18th coefficient H | −7.445E+00 | 2.042E+00 | 1.417E−01 | −2.372E−03 | −1.760E−06 | 1.757E−06 | 1.224E−06 |
| 20th coefficient J | 5.396E+00 | −1.051E+00 | −4.541E−02 | 4.579E−04 | −3.265E−06 | −9.642E−08 | −8.110E−08 |
| 22nd coefficient L | −2.788E+00 | 3.889E−01 | 1.035E−02 | −6.241E−05 | 8.224E−07 | 3.775E−09 | 3.929E−09 |
| 24th coefficient M | 1.001E+00 | −1.007E−01 | −1.635E−03 | 5.852E−06 | −1.032E−07 | −1.023E−10 | −1.347E−10 |
| 26th coefficient N | −2.369E−01 | 1.726E−02 | 1.700E−04 | −3.584E−07 | 7.448E−09 | 1.808E−12 | 3.083E−12 |
| 28th coefficient O | 3.323E−02 | −1.757E−03 | −1.046E−05 | 1.289E−08 | −2.951E−10 | −1.857E−14 | −4.214E−14 |
| 30th coefficient P | −2.090E−03 | 8.016E−05 | 2.880E−07 | −2.063E−10 | 4.990E−12 | 8.252E−17 | 2.596E−16 |

Additionally, the optical imaging system configured described as above may have aberration characteristics as illustrated in FIG. 6.

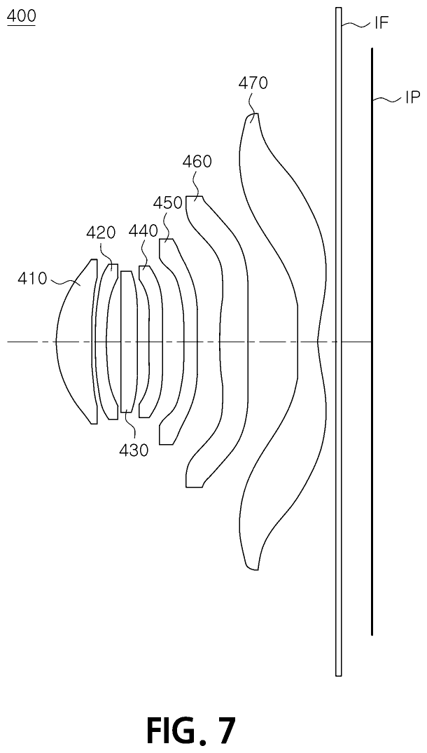

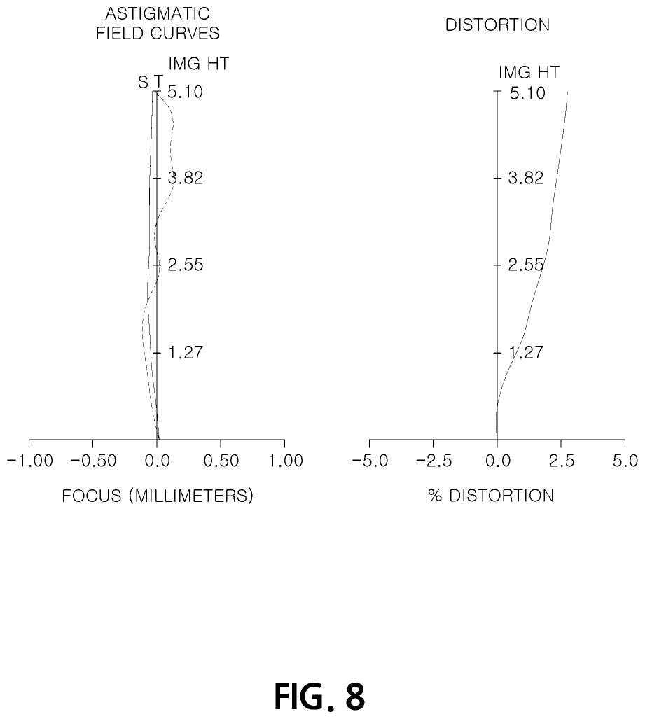

An optical imaging system 400 according to a fourth embodiment of the present disclosure will be described with reference to FIGS. 7 and 8.

The optical imaging system 400 according to the fourth embodiment of the present disclosure may include a first lens 410, a second lens 420, a third lens 430, a fourth lens 440, a fifth lens 450, a sixth lens 460, and a seventh lens 470, and may further include a filter IF and an image sensor.

The optical imaging system 400 according to the fourth embodiment of the present disclosure may form a focus on an imaging plane IP.

Lens characteristics of each lens (a radius of curvature, a thickness of a lens or a distance between lenses, a refractive index, and an Abbe number) are illustrated in Table 7.

TABLE 7

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.193 | 0.749 | 1.544 | 56.1 |
| S2 | | 8.048 | 0.099 | | |
| S3 | 2nd Lens | 10.285 | 0.230 | 1.680 | 18.2 |
| S4 | | 5.408 | 0.306 | | |
| S5 | 3rd Lens | 28.304 | 0.373 | 1.544 | 56.1 |
| S6 | | −32.822 | 0.250 | | |
| S7 | 4th Lens | −43.730 | 0.298 | 1.680 | 18.2 |
| S8 | | 67.707 | 0.450 | | |
| S9 | 5th Lens | 60.990 | 0.300 | 1.614 | 25.9 |
| S10 | | 15.299 | 0.466 | | |
| S11 | 6th Lens | 4.575 | 0.572 | 1.567 | 38.0 |
| S12 | | 101.985 | 1.066 | | |
| S13 | 7th Lens | 7.004 | 0.465 | 1.535 | 56.1 |
| S14 | | 1.875 | 0.400 | | |
| S15 | Filter | Infinity | 0.110 | 1.518 | 64.2 |
| S16 | | Infinity | 0.534 | | |
| S17 | Imaging | Infinity | | | |
| | plane | | | | |

In the fourth embodiment of the present disclosure, the first lens 410 may have positive refractive power, an object-side surface of the first lens 410 may be convex in a paraxial region, and an image-side surface of the first lens 410 may be concave in the paraxial region.

The second lens 420 may have negative refractive power, an object-side surface of the second lens 420 may be convex in a paraxial region, and an image-side surface of the second lens 420 may be concave in the paraxial region.

The third lens 430 may have positive refractive power, and an object-side surface and an image-side surface of the third lens 430 may be convex in a paraxial region.

The fourth lens 440 may have negative refractive power, and an object-side surface and an image-side surface of the fourth lens 440 may be concave in a paraxial region.

The fifth lens 450 may have negative refractive power, an object-side surface of the fifth lens 450 may be convex in a paraxial region, and an image-side surface of the fifth lens 450 may be concave in the paraxial region.

The sixth lens 460 may have positive refractive power, and an object-side surface of the sixth lens 460 may be convex in a paraxial region, and an image-side surface of the sixth lens 460 may be concave in the paraxial region.

The seventh lens 470 may have negative refractive power, an object-side surface of the seventh lens 470 may be convex in a paraxial region, and an image-side surface of the seventh lens 470 may be concave in the paraxial region.

Additionally, one or more of the sixth lens 460 and the seventh lens 470 may have at least one inflection point formed on at least one of the object-side surface or the image-side surface.

Meanwhile, each surface of the first lens 410 to the seventh lens 470 may have an aspherical coefficient, as illustrated in Table 8. For example, both the object-side surface and the image-side surface of the first lens 410 to the seventh lens 470 may be aspherical.

TABLE 8

| | S1 | S2 | S3 | S4 | S5 | S6 | S7 |
|---|---|---|---|---|---|---|---|
| Conic constant K | −5.760E−01 | 5.905E+00 | 4.014E+01 | 3.072E+00 | 0.000E+00 | −9.900E+01 | 0.000E+00 |
| 4th coefficient A | 5.301E−02 | 3.152E−02 | 2.429E−03 | 5.838E−03 | −8.411E−02 | −2.066E−02 | −2.792E−02 |
| 6th coefficient B | −4.764E−01 | −3.528E−01 | −7.608E−02 | −6.637E−02 | 9.495E−01 | −1.410E−01 | −2.957E−01 |
| 8th coefficient C | 2.535E+00 | 1.891E+00 | 3.716E−01 | 4.881E−01 | −7.327E+00 | 1.369E+00 | 1.554E+00 |
| 10th coefficient D | −8.122E+00 | −6.335E+00 | −9.906E−01 | −2.047E+00 | 3.542E+01 | −6.919E+00 | −5.400E+00 |
| 12th coefficient E | 1.714E+01 | 1.428E+01 | 1.672E+00 | 5.809E+00 | −1.137E+02 | 2.194E+01 | 1.402E+01 |
| 14th coefficient F | −2.502E+01 | −2.258E+01 | −1.813E+00 | −1.158E+01 | 2.529E+02 | −4.659E+01 | −2.875E+01 |
| 16th coefficient G | 2.604E+01 | 2.562E+01 | 1.160E+00 | 1.641E+01 | −3.994E+02 | 6.852E+01 | 4.647E+01 |
| 18th coefficient H | −1.959E+01 | −2.113E+01 | −2.224E−01 | −1.654E+01 | 4.540E+02 | −7.084E+01 | −5.771E+01 |
| 20th coefficient J | 1.069E+01 | 1.268E+01 | −3.233E−01 | 1.173E+01 | −3.725E+02 | 5.151E+01 | 5.342E+01 |
| 22nd coefficient L | −4.192E+00 | −5.476E+00 | 3.522E−01 | −5.710E+00 | 2.184E+02 | −2.591E+01 | −3.580E+01 |
| 24th coefficient M | 1.150E+00 | 1.658E+00 | −1.779E−01 | 1.817E+00 | −8.921E+01 | 8.676E+00 | 1.676E+01 |
| 26th coefficient N | −2.096E−01 | −3.337E−01 | 5.201E−02 | −3.431E−01 | 2.410E+01 | −1.787E+00 | −5.184E+00 |
| 28th coefficient O | 2.279E−02 | 4.012E−02 | −8.468E−03 | 3.031E−02 | −3.869E+00 | 1.908E−01 | 9.495E−01 |
| 30th coefficient P | −1.119E−03 | −2.178E−03 | 5.973E−04 | −3.613E−04 | 2.793E−01 | −6.322E−03 | −7.793E−02 |
| | S8 | S9 | S10 | S11 | S12 | S13 | S14 |
| Conic constant K | 0.000E+00 | 0.000E+00 | −2.136E+01 | −1.564E+01 | −9.900E+01 | 1.048E+00 | −7.583E+00 |
| 4th coefficient A | −3.332E−02 | −8.919E−02 | −1.390E−01 | −1.285E−02 | 7.557E−03 | −1.693E−01 | −7.959E−02 |
| 6th coefficient B | −2.813E−01 | −5.804E−02 | 1.639E−01 | −2.733E−02 | −1.445E−02 | 8.119E−02 | 3.748E−02 |
| 8th coefficient C | 1.842E+00 | 5.733E−01 | −3.161E−01 | 5.387E−02 | 1.773E−02 | −3.000E−02 | −1.406E−02 |
| 10th coefficient D | −6.939E+00 | −1.714E+00 | 5.253E−01 | −7.136E−02 | −2.001E−02 | 8.409E−03 | 4.008E−03 |
| 12th coefficient E | 1.720E+01 | 3.040E+00 | −6.272E−01 | 5.950E−02 | 1.375E−02 | −1.722E−03 | −8.623E−04 |
| 14th coefficient F | −2.969E+01 | −3.530E+00 | 5.299E−01 | −3.332E−02 | −6.094E−03 | 2.572E−04 | 1.402E−04 |
| 16th coefficient G | 3.673E+01 | 2.760E+00 | −3.200E−01 | 1.307E−02 | 1.847E−03 | −2.823E−05 | −1.722E−05 |
| 18th coefficient H | −3.304E+01 | −1.446E+00 | 1.392E−01 | −3.663E−03 | −3.939E−04 | 2.290E−06 | 1.593E−06 |
| 20th coefficient J | 2.164E+01 | 4.827E−01 | −4.372E−02 | 7.348E−04 | 5.961E−05 | −1.371E−07 | −1.097E−07 |
| 22nd coefficient L | −1.022E+01 | −8.530E−02 | 9.810E−03 | −1.043E−04 | −6.339E−06 | 5.987E−09 | 5.512E−09 |
| 24th coefficient M | 3.388E+00 | −6.253E−04 | −1.534E−03 | 1.021E−05 | 4.608E−07 | −1.856E−10 | −1.954E−10 |
| 26th coefficient N | −7.486E−01 | 3.695E−03 | 1.588E−04 | −6.525E−07 | −2.164E−08 | 3.877E−12 | 4.615E−12 |
| 28th coefficient O | 9.901E−02 | −7.087E−04 | −9.777E−06 | 2.451E−08 | 5.860E−10 | −4.899E−14 | −6.496E−14 |
| 30th coefficient P | −5.928E−03 | 4.608E−05 | 2.707E−07 | −4.097E−10 | −6.859E−12 | 2.834E−16 | 4.113E−16 |

Additionally, the optical imaging system configured described as above may have aberration characteristics as illustrated in FIG. 8.

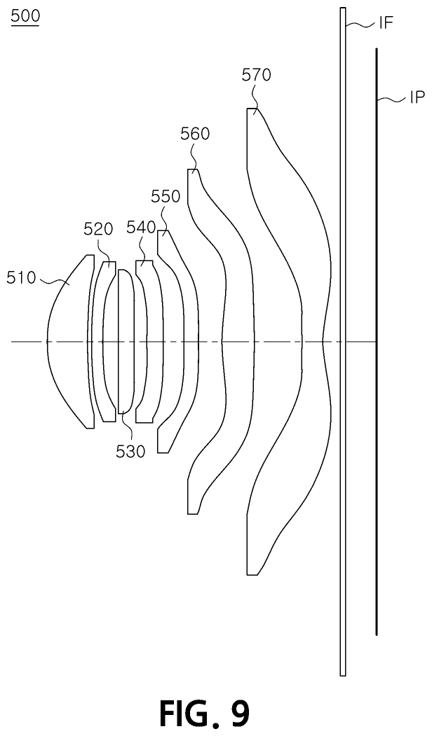

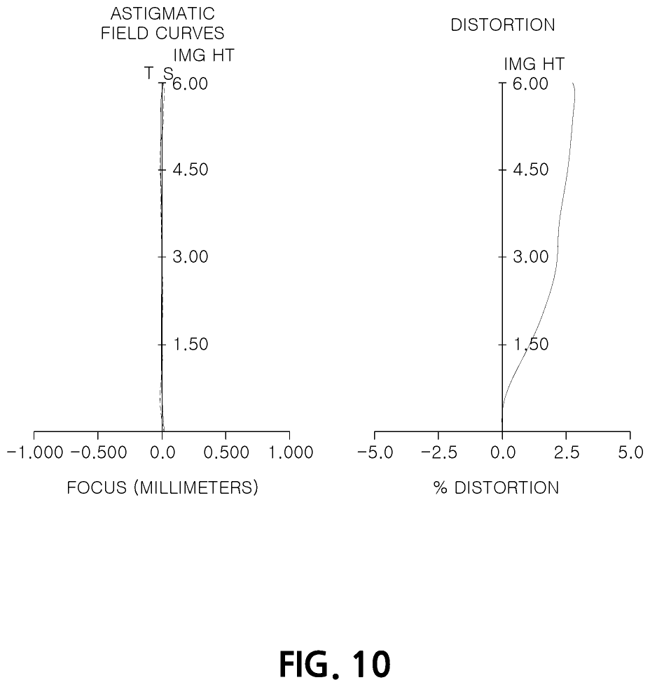

An optical imaging system 500 according to a fifth embodiment of the present disclosure will be described with reference to FIGS. 9 and 10.

The optical imaging system 500 according to the fifth embodiment of the present disclosure may include a first lens 510, a second lens 520, a third lens 530, a fourth lens 540, a fifth lens 550, a sixth lens 560, and a seventh lens 570, and may further include a filter IF and an image sensor.

The optical imaging system 500 according to the fifth embodiment of the present disclosure may form a focus on an imaging plane IP.

Lens characteristics of each lens (a radius of curvature, a thickness of a lens or a distance between lenses, a refractive index, and an Abbe number) are illustrated in Table 9.

TABLE 9

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.274 | 0.864 | 1.544 | 56.1 |
| S2 | | 11.209 | 0.100 | | |
| S3 | 2nd Lens | 14.804 | 0.220 | 1.671 | 19.2 |
| S4 | | 5.513 | 0.342 | | |
| S5 | 3rd Lens | 25.745 | 0.348 | 1.544 | 56.1 |
| S6 | | −145.152 | 0.260 | | |
| S7 | 4th Lens | 570.632 | 0.351 | 1.671 | 19.2 |
| S8 | | 29.989 | 0.450 | | |
| S9 | 5th Lens | 34.280 | 0.311 | 1.614 | 25.9 |
| S10 | | 13.934 | 0.522 | | |
| S11 | 6th Lens | 5.094 | 0.682 | 1.567 | 38.0 |
| S12 | | −50.742 | 1.028 | | |
| S13 | 7th Lens | 8.339 | 0.459 | 1.535 | 56.1 |
| S14 | | 2.048 | 0.400 | | |
| S15 | Filter | Infinity | 0.110 | 1.518 | 64.2 |
| S16 | | Infinity | 0.573 | | |
| S17 | Imaging | Infinity | | | |
| | plane | | | | |

In the fifth embodiment of the present disclosure, the first lens 510 may have positive refractive power, an object-side surface of the first lens 510 may be convex in a paraxial region, and an image-side surface of the first lens 510 may be concave in the paraxial region.

The second lens 520 may have negative refractive power, an object-side surface of the second lens 520 may be convex in a paraxial region, and an image-side surface of the second lens 520 may be concave in the paraxial region.

The third lens 530 may have positive refractive power, and an object-side surface and an image-side surface of the third lens 530 may be convex in a paraxial region.

The fourth lens 540 may have negative refractive power, an object-side surface of the fourth lens 540 may be convex in a paraxial region, and an image-side surface of the fourth lens 540 may be concave in the paraxial region.

The fifth lens 550 may have negative refractive power, an object-side surface of the fifth lens 550 may be convex in a paraxial region, and an image-side surface of the fifth lens 550 may be concave in the paraxial region.

The sixth lens 560 may have positive refractive power, and an object-side surface and an image-side surface of the sixth lens 560 may be convex in a paraxial region.

The seventh lens 570 may have negative refractive power, an object-side surface of the seventh lens 570 may be convex in a paraxial region, and an image-side surface of the seventh lens 570 may be concave in the paraxial region.

Additionally, one or more of the sixth lens 560 and the seventh lens 570 may have at least one inflection point formed on at least one of the object-side surface or the image-side surface.

Meanwhile, each surface of the first lens 510 to the seventh lens 570 may have an aspherical coefficient, as illustrated in Table 10. For example, both the object-side surface and the image-side surface of the first lens 510 to the seventh lens 570 may be aspherical.

TABLE 10

| | S1 | S2 | S3 | S4 | S5 | S6 | S7 |
|---|---|---|---|---|---|---|---|
| Conic constant K | −4.657E−01 | 2.483E+01 | 8.557E+01 | 3.715E+00 | −9.654E+01 | −9.900E+01 | 9.900E+01 |
| 4th coefficient A | 5.739E−03 | 1.555E−03 | 5.914E−03 | 1.521E−04 | −1.765E−02 | −3.033E−02 | −5.109E−02 |
| 6th coefficient B | −3.213E−03 | 1.194E−02 | −1.746E−02 | 4.812E−02 | 1.272E−02 | 5.341E−02 | 3.101E−02 |
| 8th coefficient C | 2.987E−02 | −8.124E−02 | 1.054E−01 | −4.177E−01 | −1.144E−01 | −3.111E−01 | −1.984E−01 |
| 10th coefficient D | −1.093E−01 | 3.105E−01 | −3.913E−01 | 2.194E+00 | 7.618E−01 | 1.256E+00 | 9.789E−01 |
| 12th coefficient E | 2.524E−01 | −7.675E−01 | 9.835E−01 | −7.398E+00 | −3.134E+00 | −3.456E+00 | −3.306E+00 |
| 14th coefficient F | −3.922E−01 | 1.306E+00 | −1.718E+00 | 1.698E+01 | 8.361E+00 | 6.721E+00 | 7.560E+00 |
| 16th coefficient G | 4.255E−01 | −1.578E+00 | 2.130E+00 | −2.738E+01 | −1.508E+01 | −9.434E+00 | −1.200E+01 |
| 18th coefficient H | −3.286E−01 | 1.376E+00 | −1.895E+00 | 3.154E+01 | 1.889E+01 | 9.661E+00 | 1.345E+01 |
| 20th coefficient J | 1.816E−01 | −8.669E−01 | 1.211E+00 | 2.605E+01 | −1.662E+01 | −7.224E+00 | −1.073E+01 |
| 22nd coefficient L | −7.137E−02 | 3.909E−01 | −5.514E−01 | 1.530E+01 | 1.025E+01 | 3.901E+00 | 6.051E+00 |
| 24th coefficient M | 1.945E−02 | −1.229E−01 | 1.741E−01 | −6.234E+00 | −4.333E+00 | −1.482E+00 | −2.352E+00 |
| 26th coefficient N | −3.497E−03 | 2.556E−02 | −3.620E−02 | 1.673E+00 | 1.196E+00 | 3.753E−01 | 5.991E−01 |
| 28th coefficient O | 3.729E−04 | −3.162E−03 | 4.455E−03 | −2.658E−01 | −1.943E−01 | −5.690E−02 | −8.980E−02 |
| 30th coefficient P | −1.787E−05 | 1.759E−04 | −2.455E−04 | 1.892E−02 | 1.406E−02 | 3.902E−03 | 5.991E−03 |
| | S8 | S9 | S10 | S11 | S12 | S13 | S14 |
| Conic constant K | 7.018E+01 | 9.720E+00 | −2.561E+01 | −1.651E+01 | −9.709E+01 | 1.297E+00 | −8.197E+00 |
| 4th coefficient A | −4.702E−02 | −8.037E−02 | −1.160E−01 | −2.379E−02 | −4.845E−03 | −1.518E−01 | −7.167E−02 |
| 6th coefficient B | 5.101E−02 | −1.954E−02 | 9.828E−02 | 9.883E−03 | 7.190E−03 | 6.835E−02 | 3.079E−02 |
| 8th coefficient C | −2.032E−01 | 3.296E−01 | −1.278E−01 | −1.516E−02 | −1.028E−02 | −2.329E−02 | −1.005E−02 |
| 10th coefficient D | 6.096E−01 | −1.061E+00 | 1.522E−01 | 1.370E−02 | 6.840E−03 | 5.916E−03 | 2.424E−03 |
| 12th coefficient E | −1.299E+00 | 2.045E+00 | −1.398E−01 | −9.407E−03 | −3.227E−03 | −1.066E−03 | −4.329E−04 |
| 14th coefficient F | 1.954E+00 | −2.665E+00 | 9.443E−02 | 4.828E−03 | 1.160E−03 | 1.342E−04 | 5.737E−05 |
| 16th coefficient G | −2.106E+00 | 2.447E+00 | −4.657E−02 | −1.795E−03 | −3.179E−04 | −1.164E−05 | −5.657E−06 |
| 18th coefficient H | 1.644E+00 | −1.612E+00 | 1.669E−02 | 4.726E−04 | 6.517E−05 | 6.638E−07 | 4.158E−07 |
| 20th coefficient J | −9.306E−01 | 7.648E−01 | −4.303E−03 | −8.693E−05 | −9.805E−06 | −2.121E−08 | −2.276E−08 |
| 22nd coefficient L | 3.783E−01 | −2.587E−01 | 7.856E−04 | 1.104E−05 | 1.061E−06 | 3.841E−11 | 9.194E−10 |
| 24th coefficient M | −1.076E−01 | 6.078E−02 | −9.916E−05 | −9.474E−07 | −8.016E−08 | 2.878E−11 | −2.678E−11 |
| 26th coefficient N | 2.029E−02 | −9.412E−03 | 8.282E−06 | 5.246E−08 | 4.011E−09 | −1.276E−12 | 5.349E−13 |
| 28th coefficient O | −2.278E−03 | 8.627E−04 | −4.173E−07 | −1.693E−09 | −1.194E−10 | 2.518E−14 | −6.587E−15 |
| 30th coefficient P | 1.150E−04 | −3.541E−05 | 9.785E−09 | 2.423E−11 | 1.598E−12 | −2.004E−16 | 3.779E−17 |

Additionally, the optical imaging system configured described as above may have aberration characteristics as illustrated in FIG. 10.

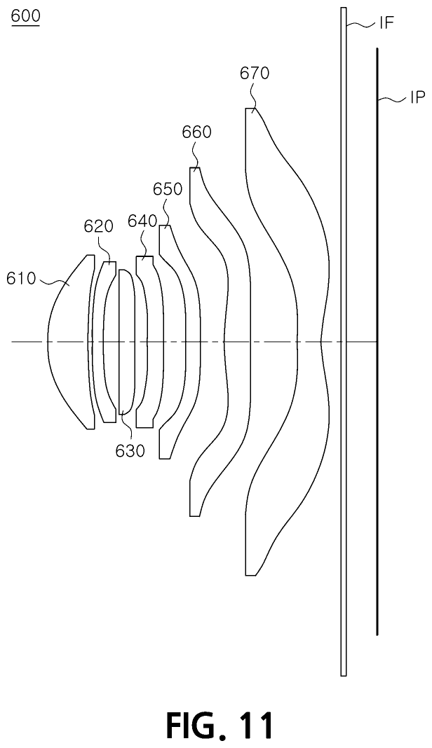

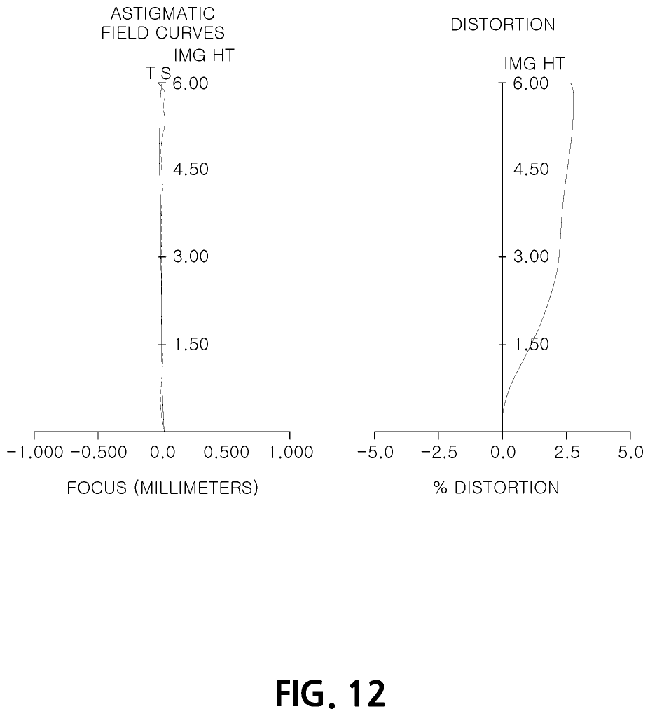

An optical imaging system 600 according to a sixth embodiment of the present disclosure will be described with reference to FIGS. 11 and 12.

The optical imaging system 600 according to the sixth embodiment of the present disclosure may include a first lens 610, a second lens 620, a third lens 630, a fourth lens 640, a fifth lens 650, a sixth lens 660, and a seventh lens 670, and may further include a filter IF and an image sensor.

The optical imaging system 600 according to the sixth embodiment of the present disclosure may form a focus on an imaging plane IP.

Lens characteristics of each lens (a radius of curvature, a thickness of a lens or a distance between lenses, a refractive index, and an Abbe number) are illustrated in Table 11.

TABLE 11

| Surface | | Curvature | Thickness or | Refractive | Abbe |
|---|---|---|---|---|---|
| No. | | Radius | Distance | Index | No. |
| S0 | Stop | Infinity | −0.724 | | |
| S1 | 1st Lens | 2.287 | 0.855 | 1.544 | 56.1 |
| S2 | | 11.139 | 0.100 | | |
| S3 | 2nd Lens | 15.092 | 0.230 | 1.671 | 19.2 |
| S4 | | 5.500 | 0.331 | | |
| S5 | 3rd Lens | 26.393 | 0.355 | 1.544 | 56.1 |
| S6 | | −70.363 | 0.266 | | |
| S7 | 4th Lens | −83.725 | 0.360 | 1.671 | 19.2 |
| S8 | | 43.225 | 0.450 | | |
| S9 | 5th Lens | 30.826 | 0.310 | 1.614 | 25.9 |
| S10 | | 14.213 | 0.500 | | |
| S11 | 6th Lens | 4.544 | 0.562 | 1.567 | 38.0 |
| S12 | | 147.581 | 1.013 | | |
| S13 | 7th Lens | 10.018 | 0.536 | 1.535 | 56.1 |
| S14 | | 2.191 | 0.400 | | |
| S15 | Filter | Infinity | 0.110 | 1.518 | 64.2 |
| S16 | | Infinity | 0.642 | | |
| S17 | Imaging | Infinity | | | |
| | plane | | | | |

In the sixth embodiment of the present disclosure, the first lens 610 may have positive refractive power, an object-side surface of the first lens 610 may be convex in a paraxial region, and an image-side surface of the first lens 610 may be concave in the paraxial region.

The second lens 620 may have negative refractive power, an object-side surface of the second lens 620 may be convex in a paraxial region, and an image-side surface of the second lens 620 may be concave in the paraxial region.

The third lens 630 may have positive refractive power, and an object-side surface and an image-side surface of the third lens 630 may be convex in a paraxial region.

The fourth lens 640 may have negative refractive power, and an object-side surface and an image-side surface of the fourth lens 640 may be concave in a paraxial region.

The fifth lens 650 may have negative refractive power, an object-side surface of the fifth lens 650 may be convex in a paraxial region, and an image-side surface of the fifth lens 650 may be concave in the paraxial region.

The sixth lens 660 may have positive refractive power, and an object-side surface of the sixth lens 660 may be convex in a paraxial region, and an image-side surface of the sixth lens 660 may be concave in the paraxial region.

The seventh lens 670 may have negative refractive power, an object-side surface of the seventh lens 670 may be convex in a paraxial region, and an image-side surface of the seventh lens 670 may be concave in the paraxial region.

Additionally, one or more of the sixth lens 660 and the seventh lens 670 may have at least one inflection point formed on at least one of the object-side surface or the image-side surface.

Meanwhile, each surface of the first lens 610 to the seventh lens 670 may have an aspherical coefficient, as illustrated in Table 12. For example, both the object-side surface and the image-side surface of the first lens 610 to the seventh lens 670 may be aspherical.

TABLE 12

| | S1 | S2 | S3 | S4 | S5 | S6 | S7 |
|---|---|---|---|---|---|---|---|
| Conic constant K) | −4.941E−01 | 2.464E+01 | 8.829E+01 | 3.612E+00 | 2.340E+01 | −9.900E+01 | −9.900E+01 |
| 4th coefficient A | 7.272E−03 | 3.635E−03 | 9.074E−03 | 2.585E−03 | −1.641E−02 | −2.805E−02 | −5.144E−02 |
| 6th coefficient B | −1.390E−02 | 4.979E−03 | −2.655E−02 | 3.376E−02 | −4.795E−03 | 3.125E−02 | 2.055E−02 |
| 8th coefficient C | 7.374E−02 | −5.780E−02 | 1.496E−01 | −3.134E−01 | 9.470E−03 | −2.022E−01 | −7.988E−02 |
| 10th coefficient D | −2.241E−01 | 2.562E−01 | −5.687E−01 | 1.649E+00 | 1.506E−01 | 9.897E−01 | 2.722E−01 |
| 12th coefficient E | 4.558E−01 | −6.902E−01 | 1.467E+00 | −5.524E+00 | −1.081E+00 | −3.307E+00 | −7.901E−01 |
| 14th coefficient F | −6.467E−01 | 1.249E+00 | −2.620E+00 | 1.259E+01 | 3.603E+00 | 7.679E+00 | 1.721E+00 |
| 16th coefficient G | 6.555E−01 | −1.582E+00 | 3.312E+00 | −2.021E+01 | −7.320E+00 | −1.259E+01 | −2.702E+00 |
| 18th coefficient H | −4.804E−01 | 1.430E+00 | −2.999E+00 | 2.321E+01 | 9.866E+00 | 1.475E+01 | 3.035E+00 |
| 20th coefficient J | 2.549E−01 | −9.272E−01 | 1.950E+00 | −1.915E+01 | −9.117E+00 | −1.238E+01 | −2.424E+00 |
| 22nd coefficient L | −9.693E−02 | 4.272E−01 | −9.023E−01 | 1.125E+01 | 5.812E+00 | 7.384E+00 | 1.358E+00 |
| 24th coefficient M | 2.572E−02 | −1.365E−01 | 2.897E−01 | −4.584E+00 | −2.514E+00 | −3.051E+00 | −5.167E−01 |
| 26th coefficient N | −4.523E−03 | 2.872E−02 | −6.132E−02 | 1.232E+00 | 7.044E−01 | 8.303E−01 | 1.260E−01 |
| 28th coefficient O | 4.732E−04 | −3.580E−03 | 7.690E−03 | −1.959E−01 | −1.153E−01 | −1.338E−01 | −1.749E−02 |
| 30th coefficient P | −2.230E−05 | 2.001E−04 | −4.327E−04 | 1.397E−02 | 8.353E−03 | 9.663E−03 | 1.022E−03 |
| | S8 | S9 | S10 | S11 | S12 | S13 | S14 |
| Conic constant K | 9.900E+01 | 2.631E+01 | −2.576E+01 | −1.491E+01 | −9.900E+01 | 2.720E+00 | −8.280E+00 |
| 4th coefficient A | −4.508E−02 | −7.008E−02 | −1.066E−01 | −1.138E−02 | 5.794E−03 | −1.266E−01 | −5.966E−02 |
| 6th coefficient B | 3.929E−02 | −5.209E−02 | 6.092E−02 | 1.183E−04 | 6.674E−05 | 5.176E−02 | 2.220E−02 |
| 8th coefficient C | −1.704E−01 | 3.813E−01 | −4.936E−02 | −1.338E−02 | −8.955E−03 | −1.791E−02 | −6.635E−03 |
| 10th coefficient D | 5.589E−01 | −1.052E+00 | 4.347E−02 | 1.782E−02 | 8.095E−03 | 5.249E−03 | 1.500E−03 |
| 12th coefficient E | −1.270E+00 | 1.845E+00 | −3.249E−02 | −1.423E−02 | −4.469E−03 | −1.184E−03 | −2.505E−04 |
| 14th coefficient F | 1.997E+00 | −2.242E+00 | 1.779E−02 | 7.604E−03 | 1.728E−03 | 1.976E−04 | 3.035E−05 |
| 16th coefficient G | −2.222E+00 | 1.942E+00 | −6.779E−03 | −2.808E−03 | −4.816E−04 | −2.420E−05 | −2.634E−06 |
| 18th coefficient H | 1.776E+00 | −1.216E+00 | 1.676E−03 | 7.235E−04 | 9.719E−05 | 2.174E−06 | 1.611E−07 |
| 20th coefficient J | −1.023E+00 | 5.505E−01 | −2.106E−04 | −1.302E−04 | −1.411E−05 | −1.427E−07 | −6.723E−09 |
| 22nd coefficient L | 4.215E−01 | −1.783E−01 | −8.977E−06 | 1.624E−05 | 1.455E−06 | 6.754E−09 | 1.777E−10 |
| 24th coefficient M | −1.209E−01 | 4.022E−02 | 7.940E−06 | −1.374E−06 | −1.038E−07 | −2.244E−10 | −2.331E−12 |
| 26th coefficient N | 2.291E−02 | −5.990E−03 | −1.255E−06 | 7.529E−08 | 4.873E−09 | 4.961E−12 | −8.827E−15 |
| 28th coefficient O | −2.577E−03 | 5.288E−04 | 8.928E−08 | −2.411E−09 | −1.355E−10 | −6.547E−14 | 7.316E−16 |
| 30th coefficient P | 1.299E−04 | −2.093E−05 | −2.444E−09 | 3.427E−11 | 1.693E−12 | 3.900E−16 | −7.258E−18 |

Additionally, the optical imaging system configured as described above may have aberration characteristics as illustrated in FIG. 12.

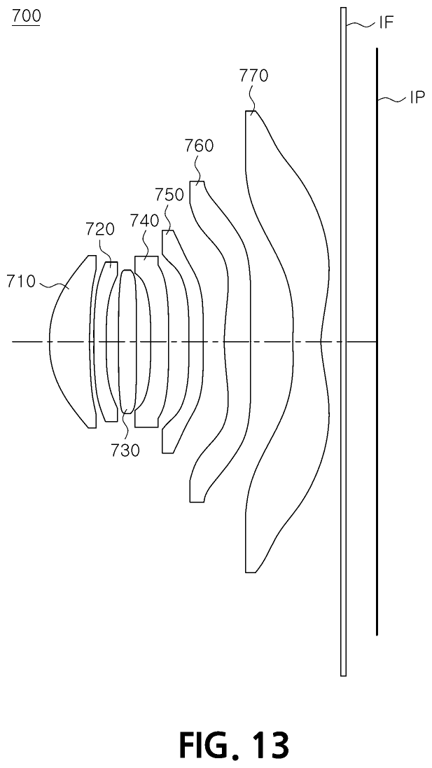

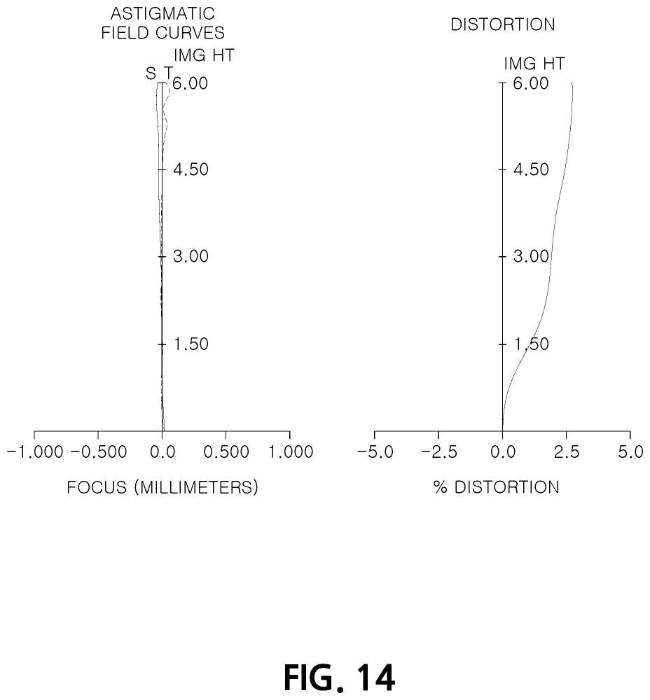

An optical imaging system 700 according to a seventh embodiment of the present disclosure will be described with reference to FIGS. 13 and 14.

The optical imaging system 700 according to the seventh embodiment of the present disclosure may include a first lens 710, a second lens 720, a third lens 730, a fourth lens 740, a fifth lens 750, a sixth lens 760, and a seventh lens 770, and may further include a filter IF and an image sensor.

The optical imaging system 700 according to the seventh embodiment of the present disclosure may form a focus on an imaging plane IP.

Lens characteristics of each lens (a radius of curvature, a thickness of a lens or a distance between lenses, a refractive index, and an Abbe number) are illustrated in Table 13.

TABLE 13

| Surface | | Curvature | Thickness or | Refractive | Abbe |
|---|---|---|---|---|---|
| No. | | Radius | Distance | Index | No. |
| S0 | Stop | Infinity | −0.724 | | |
| S1 | 1st Lens | 2.274 | 0.856 | 1.544 | 56.1 |
| S2 | | 10.753 | 0.110 | | |
| S3 | 2nd Lens | 14.901 | 0.243 | 1.671 | 19.2 |
| S4 | | 5.318 | 0.271 | | |
| S5 | 3rd Lens | 11.931 | 0.377 | 1.544 | 56.1 |
| S6 | | 60.086 | 0.309 | | |
| S7 | 4th Lens | −36.938 | 0.391 | 1.671 | 19.2 |
| S8 | | 59.780 | 0.450 | | |
| S9 | 5th Lens | 38.988 | 0.312 | 1.614 | 25.9 |
| S10 | | 14.622 | 0.415 | | |
| S11 | 6th Lens | 4.409 | 0.562 | 1.567 | 38.0 |
| S12 | | 79.514 | 0.957 | | |
| S13 | 7th Lens | 11.442 | 0.623 | 1.535 | 56.1 |
| S14 | | 2.270 | 0.400 | | |
| S15 | Filter | Infinity | 0.110 | 1.518 | 64.2 |
| S16 | | Infinity | 0.633 | | |
| S17 | Imaging | Infinity | | | |
| | plane | | | | |

In the seventh embodiment of the present disclosure, the first lens 710 may have positive refractive power, an object-side surface of the first lens 710 may be convex in a paraxial region, and an image-side surface of the first lens 710 may be concave in the paraxial region.

The second lens 720 may have negative refractive power, an object-side surface of the second lens 720 may be convex in a paraxial region, and an image-side surface of the second lens 720 may be concave in the paraxial region.

The third lens 730 may have positive refractive power, and an object-side surface of the third lens 730 may be convex in a paraxial region, and an image-side surface of the third lens 830 may be concave in the paraxial region.

The fourth lens 740 may have negative refractive power, and an object-side surface and an image-side surface of the fourth lens 740 may be concave in a paraxial region.

The fifth lens 750 may have negative refractive power, an object-side surface of the fifth lens 750 may be convex in a paraxial region, and an image-side surface of the fifth lens 750 may be concave in the paraxial region.

The sixth lens 760 may have positive refractive power, and an object-side surface of the sixth lens 760 may be convex in a paraxial region, and an image-side surface of the sixth lens 760 may be concave in the paraxial region.

The seventh lens 770 may have negative refractive power, an object-side surface of the seventh lens 770 may be convex in a paraxial region, and an image-side surface of the seventh lens 770 may be concave in the paraxial region.

Additionally, one or more of the sixth lens 760 and the seventh lens 770 may have at least one inflection point formed on at least one of the object-side surface or the image-side surface.

Meanwhile, each surface of the first lens 710 to the seventh lens 770 may have an aspherical coefficient, as illustrated in Table 14. For example, both the object-side surface and the image-side surface of the first lens 710 to the seventh lens 770 may be aspherical.

TABLE 14

| | S1 | S2 | S3 | S4 | S5 | S6 | S7 |
|---|---|---|---|---|---|---|---|
| Conic constant K | −4.774E−01 | 2.493E+01 | 8.299E+01 | 1.804E+00 | 0.000E+00 | 9.900E+01 | −7.251E+01 |
| 4th coefficient A | 7.283E−03 | 1.162E−02 | 2.003E−02 | 1.309E−02 | −4.184E−03 | −1.260E−02 | −4.687E−02 |
| 6th coefficient B | −1.131E−02 | −1.854E−02 | −5.494E−02 | 5.394E−03 | 5.279E−03 | −1.766E−02 | 4.604E−03 |
| 8th coefficient C | 5.060E−02 | 5.506E−03 | 2.109E−01 | −2.227E−01 | −1.398E−01 | 1.995E−01 | 1.032E−01 |
| 10th coefficient D | −1.307E−01 | 1.231E−01 | −7.115E−01 | 1.350E+00 | 8.956E−01 | −1.031E+00 | −8.261E−01 |
| 12th coefficient E | 2.356E−01 | −4.997E−01 | 1.736E+00 | −4.805E+00 | −3.390E+00 | 3.165E+00 | 3.171E+00 |
| 14th coefficient F | −3.088E−01 | 1.063E+00 | −3.004E+00 | 1.139E+01 | 8.468E+00 | −6.357E+00 | −7.715E+00 |
| 16th coefficient G | 3.003E−01 | −1.456E+00 | 3.730E+00 | −1.883E+01 | −1.463E+01 | 8.736E+00 | 1.286E+01 |
| 18th coefficient H | −2.181E−01 | 1.368E+00 | −3.346E+00 | 2.214E+01 | 1.787E+01 | −8.371E+00 | −1.517E+01 |
| 20th coefficient J | 1.177E−01 | −9.014E−01 | 2.167E+00 | −1.864E+01 | −1.554E+01 | 5.594E+00 | 1.281E+01 |
| 22nd coefficient L | −4.637E−02 | 4.173E−01 | −1.001E+00 | 1.114E+01 | 9.556E+00 | −2.556E+00 | −7.698E+00 |
| 24th coefficient M | 1.294E−02 | −1.331E−01 | 3.212E−01 | −4.614E+00 | −4.056E+00 | 7.612E−01 | 3.220E+00 |
| 26th coefficient N | −2.414E−03 | 2.786E−02 | −6.787E−02 | 1.257E+00 | 1.130E+00 | −1.331E−01 | −8.912E−01 |
| 28th coefficient O | 2.698E−04 | −3.447E−03 | 8.482E−03 | −2.023E−01 | −1.858E−01 | 1.038E−02 | 1.468E−01 |
| 30th coefficient P | −1.363E−05 | 1.911E−04 | −4.743E−04 | 1.457E−02 | 1.365E−02 | −6.279E−06 | −1.091E−02 |
| | S8 | S9 | S10 | S11 | S12 | S13 | S14 |
| Conic constant K | 9.717E+01 | −9.501E+00 | −3.844E+01 | −1.491E+01 | −9.817E+01 | 3.431E+00 | −8.296E+00 |
| 4th coefficient A | −4.447E−02 | −6.156E−02 | −9.621E−02 | −1.176E−02 | 2.436E−03 | −1.193E−01 | −5.646E−02 |
| 6th coefficient B | 4.939E−02 | −3.040E−02 | 4.547E−02 | −1.330E−03 | 6.448E−03 | 5.212E−02 | 2.280E−02 |
| 8th coefficient C | −2.040E−01 | 2.553E−01 | −2.319E−02 | −7.283E−03 | −1.325E−02 | −2.084E−02 | −7.881E−03 |
| 10th coefficient D | 5.903E−01 | −7.315E−01 | −2.436E−03 | 6.916E−03 | 7.986E−03 | 6.826E−03 | 2.052E−03 |
| 12th coefficient E | −1.201E+00 | 1.322E+00 | 2.688E−02 | −4.260E−03 | −2.697E−03 | −1.591E−03 | −3.917E−04 |
| 14th coefficient F | 1.738E+00 | −1.649E+00 | −3.507E−02 | 2.063E−03 | 5.412E−04 | 2.590E−04 | 5.506E−05 |
| 16th coefficient G | −1.824E+00 | 1.463E+00 | 2.607E−02 | −7.749E−04 | −5.295E−05 | −2.991E−05 | −5.753E−06 |
| 18th coefficient H | 1.401E+00 | −9.362E−01 | −1.283E−02 | 2.116E−04 | −2.510E−06 | 2.485E−06 | 4.501E−07 |
| 20th coefficient J | −7.885E−01 | 4.332E−01 | 4.365E−03 | −4.025E−05 | 1.608E−06 | −1.492E−07 | −2.639E−08 |
| 22nd coefficient L | 3.213E−01 | −1.433E−01 | −1.033E−03 | 5.220E−06 | −2.451E−07 | 6.415E−09 | 1.148E−09 |
| 24th coefficient M | −9.218E−02 | 3.300E−02 | 1.664E−04 | −4.512E−07 | 2.048E−08 | −1.928E−10 | −3.604E−11 |
| 26th coefficient N | 1.765E−02 | −5.016E−03 | −1.736E−05 | 2.485E−08 | −9.975E−10 | 3.842E−12 | 7.728E−13 |
| 28th coefficient O | −2.023E−03 | 4.515E−04 | 1.056E−06 | −7.887E−10 | 2.617E−11 | −4.561E−14 | −1.012E−14 |
| 30th coefficient P | 1.047E−04 | −1.820E−05 | −2.841E−08 | 1.098E−11 | −2.786E−13 | 2.439E−16 | 6.081E−17 |

Additionally, the optical imaging system configured as described above may have aberration characteristics as illustrated in FIG. 14.

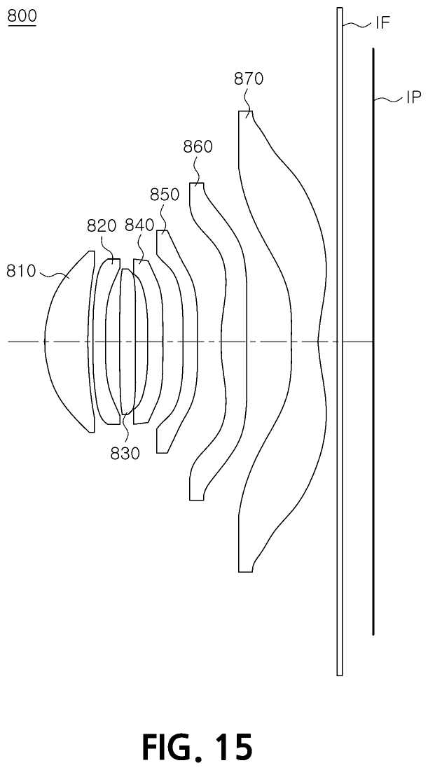

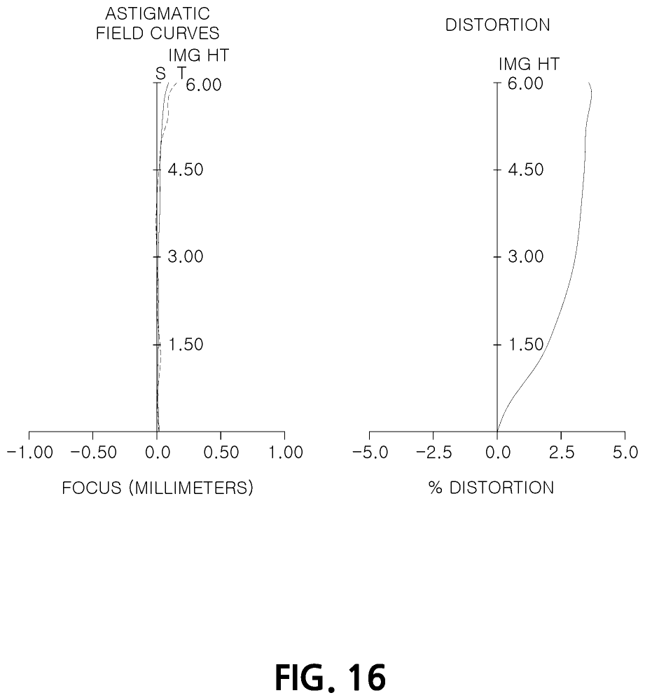

An optical imaging system 800 according to an eighth embodiment of the present disclosure will be described with reference to FIGS. 15 and 16.

The optical imaging system 800 according to the eighth embodiment of the present disclosure may include a first lens 810, a second lens 820, a third lens 830, a fourth lens 840, a fifth lens 850, a sixth lens 860, and a seventh lens 870, and may further include a filter IF and an image sensor.

The optical imaging system 800 according to the eighth embodiment of the present disclosure may form a focus on an imaging plane IP.

Lens characteristics of each lens (a radius of curvature, a thickness of a lens or a distance between lenses, a refractive index, and an Abbe number) are illustrated in Table 15.

TABLE 15

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.296 | 0.935 | 1.544 | 56.1 |
| S2 | | 10.915 | 0.100 | | |
| S3 | 2nd Lens | 15.331 | 0.260 | 1.671 | 19.2 |
| S4 | | 5.650 | 0.333 | | |
| S5 | 3rd Lens | 30.016 | 0.342 | 1.544 | 56.1 |
| S6 | | −99.720 | 0.241 | | |
| S7 | 4th Lens | −46.702 | 0.330 | 1.687 | 18.3 |
| S8 | | 91.902 | 0.450 | | |
| S9 | 5th Lens | 31.990 | 0.310 | 1.614 | 25.9 |
| S10 | | 16.196 | 0.511 | | |
| S11 | 6th Lens | 4.245 | 0.562 | 1.567 | 38.0 |
| S12 | | 39.126 | 0.945 | | |
| S13 | 7th Lens | 11.656 | 0.594 | 1.535 | 56.1 |
| S14 | | 2.276 | 0.400 | | |
| S15 | Filter | Infinity | 0.110 | 1.518 | 64.2 |
| S16 | | Infinity | 0.597 | | |
| S17 | Imaging | Infinity | | | |
| | plane | | | | |

In the eighth embodiment of the present disclosure, the first lens 810 may have positive refractive power, an object-side surface of the first lens 810 may be convex in a paraxial region, and an image-side surface of the first lens 810 may be concave in the paraxial region.

The second lens 820 may have negative refractive power, an object-side surface of the second lens 820 may be convex in a paraxial region, and an image-side surface of the second lens 820 may be concave in the paraxial region.

The third lens 830 may have positive refractive power, and an object-side surface and an image-side surface of the third lens 830 may be convex in a paraxial region.

The fourth lens 840 may have negative refractive power, and an object-side surface and an image-side surface of the fourth lens 840 may be concave in a paraxial region.

The fifth lens 850 may have negative refractive power, an object-side surface of the fifth lens 850 may be convex in a paraxial region, and an image-side surface of the fifth lens 850 may be concave in the paraxial region.

The sixth lens 860 may have positive refractive power, an object-side surface of the sixth lens 860 may be convex in a paraxial region, and an image-side surface of the sixth lens 860 may be concave shape in the paraxial region.

The seventh lens 870 may have negative refractive power, an object-side surface of the seventh lens 870 may be convex shape in a paraxial region, and an image-side surface of the seventh lens 870 may be concave in the paraxial region.

Additionally, one or more of the sixth lens 860 and the seventh lens 870 may have at least one inflection point formed on at least one of the object-side surface or the image-side surface.

Meanwhile, each surface of the first lens 810 to the seventh lens 870 may have an aspherical coefficient, as illustrated in Table 16. For example, both the object-side surface and the image-side surface of the first lens 810 to the seventh lens 870 may be aspherical.

TABLE 16

| | S1 | S2 | S3 | S4 | S5 | S6 | S7 |
|---|---|---|---|---|---|---|---|
| Conic constant K | −4.707E−01 | 9.184E+00 | 8.214E+01 | 4.750E+00 | 2.718E+01 | −9.900E+01 | 6.099E+01 |
| 4th coefficient A | 1.474E−02 | −1.771E−03 | 5.270E−03 | 9.894E−04 | −4.894E−03 | −3.891E−02 | −5.136E−02 |
| 6th coefficient B | −6.199E−02 | 1.879E−02 | −1.623E−02 | 6.474E−02 | −8.832E−02 | 1.778E−01 | −6.637E−03 |
| 8th coefficient C | 2.421E−01 | −8.526E−02 | 1.131E−01 | −4.695E−01 | 4.842E−01 | −1.113E+00 | 8.380E−02 |
| 10th coefficient D | −6.035E−01 | 2.384E−01 | −4.582E−01 | 2.125E+00 | −1.555E+00 | 4.588E+00 | −3.268E−01 |
| 12th coefficient E | 1.030E+00 | −4.327E−01 | 1.210E+00 | −6.384E+00 | 3.044E+00 | −1.298E+01 | 8.011E−01 |
| 14th coefficient F | −1.243E+00 | 5.341E−01 | −2.167E+00 | 1.335E+01 | −3.398E+00 | 2.603E+01 | −1.534E+00 |
| 16th coefficient G | 1.083E+00 | −4.606E−01 | 2.707E+00 | −1.992E+01 | 1.224E+00 | −3.777E+01 | 2.413E+00 |
| 18th coefficient H | −6.878E−01 | 2.801E−01 | −2.402E+00 | 2.151E+01 | 2.286E+00 | 3.997E+01 | −3.018E+00 |
| 20th coefficient J | 3.186E−01 | −1.196E−01 | 1.521E+00 | −1.680E+01 | −4.228E+00 | −3.082E+01 | 2.852E+00 |
| 22nd coefficient L | −1.064E−01 | 3.508E−02 | −6.829E−01 | 9.401E+00 | 3.550E+00 | 1.711E+01 | −1.950E+00 |
| 24th coefficient M | 2.492E−02 | −6.741E−03 | 2.121E−01 | −3.668E+00 | −1.786E+00 | −6.656E+00 | 9.263E−01 |
| 26th coefficient N | −3.885E−03 | 7.683E−04 | −4.332E−02 | 9.467E−01 | 5.513E−01 | 1.719E+00 | −2.887E−01 |
| 28th coefficient O | 3.620E−04 | −4.054E−05 | 5.233E−03 | −1.451E−01 | −9.663E−02 | −2.645E−01 | 5.297E−02 |
| 30th coefficient P | −1.525E−05 | 2.180E−07 | −2.831E−04 | 9.986E−03 | 7.388E−03 | 1.834E−02 | −4.334E−03 |
| | S8 | S9 | S10 | S11 | S12 | S13 | S14 |
| Conic constant K | 9.900E+01 | −1.632E+01 | −1.530E+01 | −1.735E+01 | −9.900E+01 | 4.119E+00 | −6.975E+00 |
| 4th coefficient A | −4.605E−02 | −1.035E−01 | −1.098E−01 | −1.147E−02 | 1.810E−03 | −1.249E−01 | −6.895E−02 |
| 6th coefficient B | −1.584E−02 | 1.366E−01 | 4.909E−02 | −4.342E−03 | −1.662E−02 | 4.553E−02 | 2.785E−02 |
| 8th coefficient C | 2.204E−01 | −3.424E−01 | −6.111E−03 | −3.477E−03 | 1.848E−02 | −1.305E−02 | −9.061E−03 |
| 10th coefficient D | −9.256E−01 | 7.629E−01 | −2.086E−02 | 7.966E−03 | −1.468E−02 | 3.148E−03 | 2.290E−03 |
| 12th coefficient E | 2.313E+00 | −1.226E+00 | 2.109E−02 | −7.793E−03 | 7.792E−03 | −5.644E−04 | −4.444E−04 |
| 14th coefficient F | −3.887E+00 | 1.385E+00 | −7.496E−03 | 4.589E−03 | −2.852E−03 | 6.916E−05 | 6.617E−05 |
| 16th coefficient G | 4.590E+00 | −1.111E+00 | −1.870E−03 | −1.770E−03 | 7.412E−04 | −5.406E−06 | −7.587E−06 |
| 18th coefficient H | −3.886E+00 | 6.393E−01 | 3.212E−03 | 4.617E−04 | −1.390E−04 | 2.203E−07 | 6.687E−07 |
| 20th coefficient J | 2.371E+00 | −2.641E−01 | −1.614E−03 | −8.252E−05 | 1.890E−05 | 1.999E−09 | −4.478E−08 |
| 22nd coefficient L | −1.034E+00 | 7.750E−02 | 4.687E−04 | 1.011E−05 | −1.845E−06 | −8.262E−10 | 2.226E−09 |
| 24th coefficient M | 3.147E−01 | −1.574E−02 | −8.660E−05 | −8.337E−07 | 1.258E−07 | 5.032E−11 | −7.906E−11 |
| 26th coefficient N | −6.343E−02 | 2.099E−03 | 1.012E−05 | 4.433E−08 | −5.679E−09 | −1.592E−12 | 1.885E−12 |
| 28th coefficient O | 7.615E−03 | −1.650E−04 | −6.861E−07 | −1.373E−09 | 1.521E−10 | 2.709E−14 | −2.689E−14 |
| 30th coefficient P | −4.122E−04 | 5.768E−06 | 2.068E−08 | 1.885E−11 | −1.826E−12 | −1.967E−16 | 1.730E−16 |

Additionally, the optical imaging system configured as described above may have aberration characteristics as illustrated in FIG. 16.

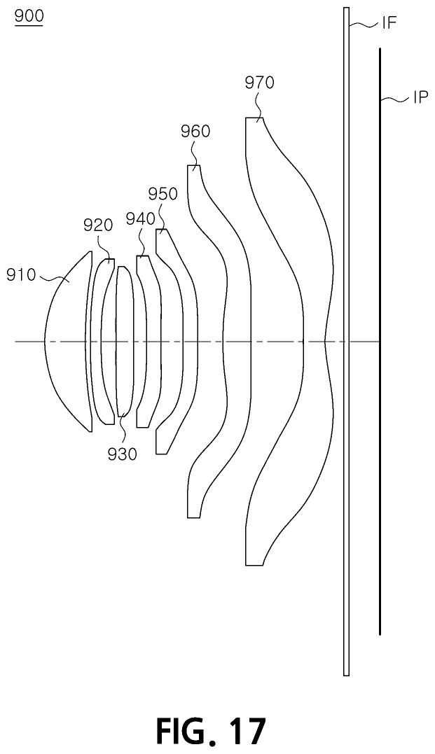

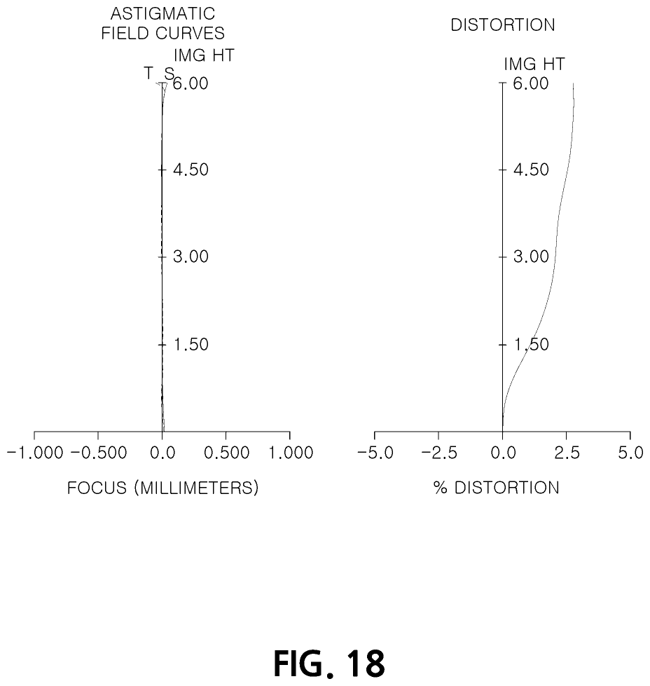

An optical imaging system 900 according to a ninth embodiment of the present disclosure will be described with reference to FIGS. 17 and 18.

The optical imaging system 900 according to the ninth embodiment of the present disclosure may include a first lens 910, a second lens 920, a third lens 930, a fourth lens 940, a fifth lens 950, a sixth lens 960, and a seventh lens 970, and may further include a filter IF and an image sensor.

The optical imaging system 900 according to the ninth embodiment of the present disclosure may form a focus on an imaging plane IP.

Lens characteristics of each lens (a radius of curvature, a thickness of a lens or a distance between lenses, a refractive index, and an Abbe number) are illustrated in Table 17.

TABLE 17

| Surface | | Curvature | Thickness or | Refractive | Abbe |
|---|---|---|---|---|---|
| No. | | Radius | Distance | Index | No. |
| S0 | Stop | Infinity | −0.730 | | |
| S1 | 1st Lens | 2.261 | 0.851 | 1.544 | 56.1 |
| S2 | | 11.233 | 0.100 | | |
| S3 | 2nd Lens | 14.757 | 0.210 | 1.671 | 19.2 |
| S4 | | 5.317 | 0.329 | | |
| S5 | 3rd Lens | 22.173 | 0.348 | 1.544 | 56.1 |
| S6 | | 191.844 | 0.254 | | |
| S7 | 4th Lens | 41.323 | 0.325 | 1.671 | 19.2 |
| S8 | | 23.134 | 0.450 | | |
| S9 | 5th Lens | 32.989 | 0.295 | 1.614 | 25.9 |
| S10 | | 13.296 | 0.532 | | |
| S11 | 6th Lens | 4.550 | 0.562 | 1.567 | 38.0 |
| S12 | | 84.201 | 1.100 | | |
| S13 | 7th Lens | 7.750 | 0.450 | 1.535 | 56.1 |
| S14 | | 2.026 | 0.400 | | |
| S15 | Filter | Infinity | 0.110 | 1.518 | 64.2 |
| S16 | | Infinity | 0.603 | | |
| S17 | Imaging | Infinity | | | |
| | plane | | | | |

In the ninth embodiment of the present disclosure, the first lens 910 may have positive refractive power, an object-side surface of the first lens 910 may be convex in a paraxial region, and an image-side surface of the first lens 910 may be concave in the paraxial region.

The second lens 920 may have negative refractive power, an object-side surface of the second lens 920 may be convex in a paraxial region, and an image-side surface of the second lens 920 may be concave in the paraxial region.

The third lens 930 may have positive refractive power, an object-side surface of the third lens 930 may be convex in a paraxial region, and an image-side surface of the third lens 930 may be concave in the paraxial region.

The fourth lens 940 may have negative refractive power, an object-side surface of the fourth lens 940 may be convex in a paraxial region, and an image-side surface of the fourth lens 940 may be concave in the paraxial region.

The fifth lens 950 may have negative refractive power, an object-side surface of the fifth lens 950 may be a convex in a paraxial region, and an image-side surface of the fifth lens 950 may be concave in the paraxial region.

The sixth lens 960 may have positive refractive power, an object-side surface of the sixth lens 960 may be convex in a paraxial region, and an image-side surface of the sixth lens 960 may be concave in the paraxial region.

The seventh lens 970 may have negative refractive power, an object-side surface of the seventh lens 970 may be convex in a paraxial region, and an image-side surface of the seventh lens 970 may be concave in the paraxial region.

Additionally, one or more of the sixth lens 960 and the seventh lens 970 may have at least one inflection point formed on at least one of the object-side surface or the image-side surface.

Meanwhile, each surface of the first lens 910 to the seventh lens 970 may have an aspherical coefficient, as illustrated in Table 18. For example, both the object-side surface and the image-side surface of the first lens 910 to the seventh lens 970 may be aspherical.

TABLE 18

| | S1 | S2 | S3 | S4 | S5 | S6 | S7 |
|---|---|---|---|---|---|---|---|
| Conic constant K | −4.769E−01 | 2.424E+01 | 8.129E+01 | 3.440E+00 | 1.325E+01 | −9.900E+01 | −9.518E+01 |
| 4th coefficient A | 6.286E−03 | −2.061E−03 | −2.453E−03 | −8.837E−03 | −2.736E−02 | −3.449E−02 | −5.562E−02 |
| 6th coefficient B | −5.158E−03 | 1.238E−02 | −1.070E−02 | 7.233E−02 | 7.189E−02 | 3.967E−02 | 7.205E−02 |
| 8th coefficient C | 2.859E−02 | −6.205E−02 | 1.684E−01 | −5.247E−01 | −5.849E−01 | −1.857E−01 | −5.915E−01 |
| 10th coefficient D | −8.192E−02 | 2.470E−01 | −7.764E−01 | 2.647E+00 | 3.136E+00 | 7.068E−01 | 3.076E+00 |
| 12th coefficient E | 1.599E−01 | −6.449E−01 | 2.209E+00 | −8.769E+00 | −1.100E+01 | −1.996E+00 | −1.046E+01 |
| 14th coefficient F | −2.218E−01 | 1.140E+00 | −4.237E+00 | 1.989E+01 | 2.630E+01 | 4.237E+00 | 2.410E+01 |
| 16th coefficient G | 2.238E−01 | −1.414E+00 | 5.681E+00 | −3.176E+01 | −4.399E+01 | −6.696E+00 | −3.874E+01 |
| 18th coefficient H | −1.660E−01 | 1.253E+00 | −5.422E+00 | 3.629E+01 | 5.230E+01 | 7.807E+00 | 4.429E+01 |
| 20th coefficient J | 9.023E−02 | −7.974E−01 | 3.700E+00 | −2.977E+01 | −4.439E+01 | −6.647E+00 | −3.620E+01 |
| 22nd coefficient L | −3.546E−02 | 3.618E−01 | −1.792E+00 | 1.738E+01 | 2.668E+01 | 4.065E+00 | 2.100E+01 |
| 24th coefficient M | 9.786E−03 | −1.141E−01 | 6.011E−01 | −7.040E+00 | −1.109E+01 | −1.734E+00 | −8.441E+00 |
| 26th coefficient N | −1.795E−03 | 2.376E−02 | −1.327E−01 | 1.879E+00 | 3.029E+00 | 4.892E−01 | 2.232E+00 |
| 28th coefficient O | 1.963E−04 | −2.936E−03 | 1.735E−02 | −2.970E−01 | −4.889E−01 | −8.187E−02 | −3.493E−01 |
| 30th coefficient P | −9.672E−06 | 1.629E−04 | −1.017E−03 | 2.104E−02 | 3.530E−02 | 6.148E−03 | 2.446E−02 |
| | S8 | S9 | S10 | S11 | S12 | S13 | S14 |
| Conic constant K | −2.165E+01 | 9.662E+01 | −3.453E+01 | −1.677E+01 | 7.124E+01 | 1.269E+00 | −8.619E+00 |
| 4th coefficient A | −4.864E−02 | −9.631E−02 | −1.347E−01 | −2.936E−02 | −1.322E−02 | −1.743E−01 | −8.438E−02 |
| 6th coefficient B | 6.181E−02 | 1.918E−02 | 1.397E−01 | 2.301E−02 | 1.513E−02 | 9.118E−02 | 4.272E−02 |
| 8th coefficient C | −3.036E−01 | 2.167E−01 | −2.305E−01 | −4.036E−02 | −2.017E−02 | −3.894E−02 | −1.688E−02 |
| 10th coefficient D | 1.030E+00 | −8.281E−01 | 3.486E−01 | 4.310E−02 | 1.510E−02 | 1.291E−02 | 4.983E−03 |
| 12th coefficient E | −2.389E+00 | 1.744E+00 | −4.035E−01 | −3.182E−02 | −7.764E−03 | −3.124E−03 | −1.096E−03 |
| 14th coefficient F | 3.835E+00 | −2.463E+00 | 3.405E−01 | 1.650E−02 | 2.885E−03 | 5.476E−04 | 1.810E−04 |
| 16th coefficient G | −4.358E+00 | 2.455E+00 | −2.083E−01 | −6.056E−03 | −7.872E−04 | −7.024E−05 | −2.253E−05 |
| 18th coefficient H | 3.556E+00 | −1.758E+00 | 9.234E−02 | 1.576E−03 | 1.577E−04 | 6.642E−06 | 2.116E−06 |
| 20th coefficient J | −2.091E+00 | 9.067E−01 | −2.952E−02 | −2.897E−04 | −2.303E−05 | −4.630E−07 | −1.485E−07 |
| 22nd coefficient L | 8.781E−01 | −3.334E−01 | 6.732E−03 | 3.721E−05 | 2.414E−06 | 2.351E−08 | 7.648E−09 |
| 24th coefficient M | −2.566E−01 | 8.512E−02 | −1.069E−03 | −3.261E−06 | −1.767E−07 | −8.464E−10 | −2.796E−10 |
| 26th coefficient N | 4.954E−02 | −1.431E−02 | 1.125E−04 | 1.858E−07 | 8.591E−09 | 2.047E−11 | 6.845E−12 |
| 28th coefficient C | −5.671E−03 | 1.422E−03 | −7.071E−06 | −6.207E−09 | −2.493E−10 | −2.985E−13 | −1.004E−13 |
| 30th coefficient P | 2.910E−04 | −6.325E−05 | 2.014E−07 | 9.225E−11 | 3.275E−12 | 1.983E−15 | 6.657E−16 |

Additionally, the optical imaging system configured as described above may have the aberration characteristics as illustrated in FIG. 18.

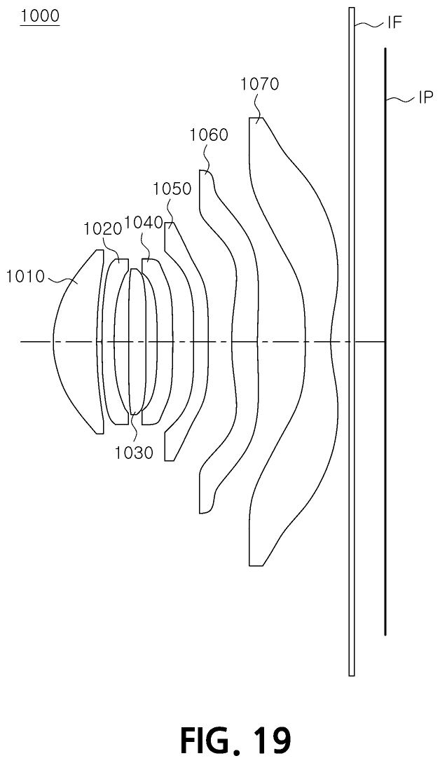

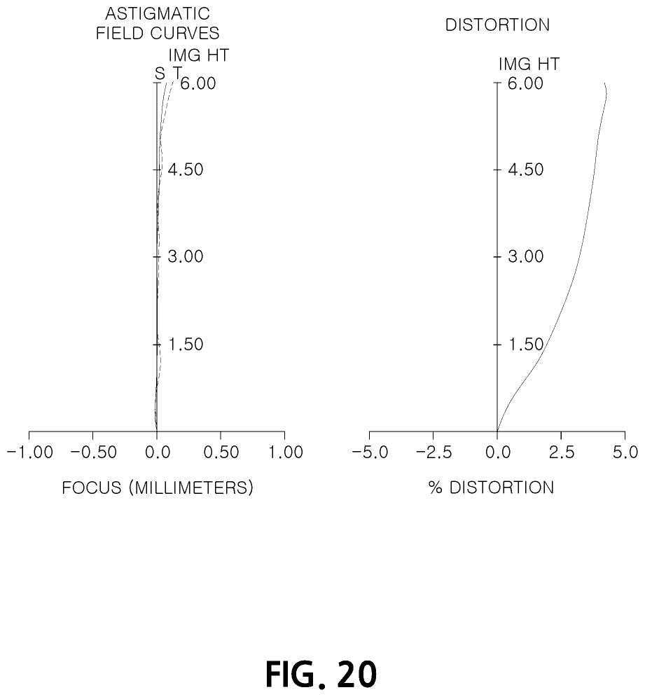

An optical imaging system 1000 according to a tenth embodiment of the present disclosure will be described with reference to FIGS. 19 and 20.

The optical imaging system 1000 according to the tenth embodiment of the present disclosure may include a first lens 1010, a second lens 1020, a third lens 1030, a fourth lens 1040, a fifth lens 1050, a sixth lens 1060, and a seventh lens 1070, and may further include a filter IF and an image sensor.

The optical imaging system 1000 according to the tenth embodiment of the present disclosure may form a focus on an imaging plane IP.

Lens characteristics of each lens (a radius of curvature, a thickness of a lens or a distance between lenses, a refractive index, and an Abbe number) are illustrated in Table 19.

TABLE 19

| Surface | | Curvature | Thickness or | Refractive | Abbe |
|---|---|---|---|---|---|
| No. | | Radius | Distance | Index | No. |
| S0 | Stop | Infinity | 0.000 | | |
| S1 | 1st Lens | 2.300 | 0.932 | 1.544 | 56.1 |
| S2 | | 10.890 | 0.100 | | |
| S3 | 2nd Lens | 15.255 | 0.260 | 1.671 | 19.2 |
| S4 | | 5.652 | 0.333 | | |
| S5 | 3rd Lens | 32.930 | 0.346 | 1.544 | 56.1 |
| S6 | | −48.344 | 0.240 | | |
| S7 | 4th Lens | −33.456 | 0.330 | 1.671 | 19.2 |
| S8 | | 147.986 | 0.450 | | |
| S9 | 5th Lens | 35.219 | 0.310 | 1.614 | 25.9 |
| S10 | | 16.413 | 0.500 | | |
| S11 | 6th Lens | 4.178 | 0.562 | 1.567 | 38.0 |
| S12 | | 30.818 | 1.001 | | |
| S13 | 7th Lens | 11.603 | 0.557 | 1.535 | 56.1 |
| S14 | | 2.286 | 0.400 | | |
| S15 | Filter | Infinity | 0.110 | 1.518 | 64.2 |
| S16 | | Infinity | 0.589 | | |
| S17 | Imaging | Infinity | | | |
| | plane | | | | |

In the tenth embodiment of the present disclosure, the first lens 1010 may have positive refractive power, an object-side surface of the first lens 1010 may be convex in a paraxial region, and an image-side surface of the first lens 1010 may be concave in the paraxial region.

The second lens 1020 may have negative refractive power, an object-side surface of the second lens 1020 may be convex in a paraxial region, and an image-side surface of the second lens 1020 may be concave in the paraxial region.

The third lens 1030 may have positive refractive power, and an object-side surface and an image-side surface of the third lens 1030 may be convex in a paraxial region.

The fourth lens 1040 may have negative refractive power, and an object-side surface and an image-side surface of the fourth lens 1040 may be concave in a paraxial region.

The fifth lens 1050 may have negative refractive power, an object-side surface of the fifth lens 1050 may be convex in a paraxial region, and an image-side surface of the fifth lens 1050 may be concave in the paraxial region.

The sixth lens 1060 may have positive refractive power, an object-side surface of the sixth lens 1060 may be convex in a paraxial region, and an image-side surface of the sixth lens 1060 may be concave in the paraxial region.

The seventh lens 1070 may have negative refractive power, an object-side surface of the seventh lens 1070 may be convex in a paraxial region, and an image-side surface of the seventh lens 1070 may be concave in the paraxial region.

Additionally, one or more of the sixth lens 1060 and the seventh lens 1070 may have at least one inflection point formed on at least one of the object-side surface or the image-side surface.

Meanwhile, each surface of the first lens 1010 to the seventh lens 1070 may have an aspherical coefficient, as illustrated in Table 20. For example, both the object-side surface and the image-side surface of the first lens 1010 to the seventh lens 1070 may be aspherical.

TABLE 20

| | S1 | S2 | S3 | S4 | S5 | S6 | S7 |
|---|---|---|---|---|---|---|---|
| Conic constant K | −4.993E−01 | 6.219E+00 | 7.876E+01 | 4.894E+00 | 5.359E+01 | −3.844E+01 | −9.783E+01 |
| 4th coefficient A | 1.424E−02 | 2.896E−03 | 5.429E−03 | 5.419E−03 | −1.704E−02 | −2.746E−02 | −6.238E−02 |
| 6th coefficient B | −5.964E−02 | −2.010E−02 | −1.744E−02 | −3.032E−03 | 6.737E−02 | 3.747E−02 | 1.127E−01 |
| 8th coefficient C | 2.421E−01 | 1.026E−01 | 1.113E−01 | 2.106E−02 | −5.710E−01 | −1.585E−01 | −7.107E−01 |
| 10th coefficient D | −6.206E−01 | −3.308E−01 | −4.377E−01 | −5.544E−02 | 2.936E+00 | 5.952E−01 | 3.067E+00 |
| 12th coefficient E | 1.079E+00 | 7.170E−01 | 1.142E+00 | 2.663E−02 | −9.802E+00 | −1.852E+00 | −9.045E+00 |
| 14th coefficient F | −1.319E+00 | −1.079E+00 | −2.037E+00 | 3.045E−01 | 2.225E+01 | 4.439E+00 | 1.860E+01 |
| 16th coefficient G | 1.158E+00 | 1.150E+00 | 2.548E+00 | −1.074E+00 | −3.539E+01 | −7.779E+00 | −2.724E+01 |
| 18th coefficient H | −7.388E−01 | −8.790E−01 | −2.270E+00 | 1.887E+00 | 4.006E+01 | 9.781E+00 | 2.879E+01 |
| 20th coefficient J | 3.426E−01 | 4.830E−01 | 1.446E+00 | −2.066E+00 | −3.242E+01 | −8.751E+00 | −2.201E+01 |
| 22nd coefficient L | −1.143E−01 | −1.890E−01 | −6.536E−01 | 1.489E+00 | 1.862E+01 | 5.508E+00 | 1.206E+01 |
| 24th coefficient M | 2.669E−02 | 5.130E−02 | 2.045E−01 | −7.081E−01 | −7.401E+00 | −2.379E+00 | −4.610E+00 |
| 26th coefficient N | −4.144E−03 | −9.177E−03 | −4.211E−02 | 2.141E−01 | 1.936E+00 | 6.709E−01 | 1.168E+00 |
| 28th coefficient O | 3.840E−04 | 9.720E−04 | 5.130E−03 | −3.734E−02 | −2.995E−01 | −1.111E−01 | −1.759E−01 |
| 30th coefficient P | −1.607E−05 | −4.613E−05 | −2.800E−04 | 2.856E−03 | 2.075E−02 | 8.192E−03 | 1.193E−02 |
| | S8 | S9 | S10 | S11 | S12 | S13 | S14 |
| Conic constant K | 9.900E+01 | −2.868E+01 | −1.649E+01 | −1.729E+01 | −9.900E+01 | 4.301E+00 | −6.777E+00 |
| 4th coefficient A | −4.825E−02 | −1.090E−01 | −1.199E−01 | −1.488E−02 | −9.622E−04 | −1.325E−01 | −7.755E−02 |
| 6th coefficient B | −1.026E−02 | 1.917E−01 | 1.018E−01 | −5.770E−03 | −1.949E−02 | 4.806E−02 | 3.245E−02 |
| 8th coefficient C | 2.300E−01 | −5.460E−01 | −1.441E−01 | 4.251E−03 | 2.538E−02 | −1.270E−02 | −1.065E−02 |
| 10th coefficient D | −1.051E+00 | 1.211E+00 | 2.102E−01 | −1.002E−03 | −2.071E−02 | 2.529E−03 | 2.678E−03 |
| 12th coefficient E | 2.762E+00 | −1.880E+00 | −2.436E−01 | −1.952E−03 | 1.097E−02 | −2.980E−04 | −5.134E−04 |
| 14th coefficient F | −4.810E+00 | 2.041E+00 | 2.059E−01 | 2.104E−03 | −3.982E−03 | 2.890E−06 | 7.554E−05 |
| 16th coefficient G | 5.842E+00 | −1.576E+00 | −1.251E−01 | −1.041E−03 | 1.026E−03 | 5.491E−06 | −8.597E−06 |
| 18th coefficient H | −5.060E+00 | 8.739E−01 | 5.462E−02 | 3.107E−04 | −1.907E−04 | −1.023E−06 | 7.578E−07 |
| 20th coefficient J | 3.148E+00 | −3.484E−01 | −1.709E−02 | −6.028E−05 | 2.567E−05 | 1.023E−07 | −5.119E−08 |
| 22nd coefficient L | −1.396E+00 | 9.884E−02 | 3.792E−03 | 7.791E−06 | −2.479E−06 | −6.540E−09 | 2.588E−09 |
| 24th coefficient M | 4.310E−01 | −1.943E−02 | −5.827E−04 | −6.672E−07 | 1.672E−07 | 2.754E−10 | −9.405E−11 |
| 26th coefficient N | −8.801E−02 | 2.510E−03 | 5.897E−05 | 3.645E−08 | −7.461E−09 | −7.429E−12 | 2.306E−12 |
| 28th coefficient O | 1.069E−02 | −1.913E−04 | −3.539E−06 | −1.152E−09 | 1.977E−10 | 1.168E−13 | −3.396E−14 |
| 30th coefficient P | −5.844E−04 | 6.490E−06 | 9.549E−08 | 1.606E−11 | −2.351E−12 | −8.166E−16 | 2.261E−16 |

Additionally, the optical imaging system configured as described above may have the aberration characteristics as illustrated in FIG. 20.

TABLE 21

| | Embodi- | Embodi- | Embodi- | Embodi- | Embodi- |
|---|---|---|---|---|---|
| | ment 1 | ment 2 | ment 3 | ment 4 | ment 5 |
| F | 6.3227 | 6.2556 | 5.9978 | 6.05 | 6.3139 |
| f1 | 5.0960 | 5.1293 | 5.3872 | 5.2773 | 5.0505 |
| f2 | −12.9257 | −13.3290 | −17.9328 | −16.8762 | −13.0625 |
| f3 | 34.6904 | 41.9131 | 28.5071 | 27.8787 | 40.0533 |
| f4 | −41.1985 | −44.3801 | −37.6727 | −38.5122 | −46.6354 |
| f5 | −43.6343 | −53.7237 | −24.6013 | −33.0193 | −38.0863 |
| f6 | 8.2469 | 8.3140 | 7.3590 | 8.3748 | 8.1469 |
| f7 | −5.3464 | −5.3887 | −5.0684 | −4.9212 | −5.1867 |
| IMG HT | 6.12 | 6.12 | 6.12 | 6.12 | 6.12 |
| Fno | 1.88 | 1.78 | 1.89 | 1.89 | 1.88 |
| FOV | 85.3 | 85.44 | 88.1 | 87.8 | 85.3 |
| | Embodi- | Embodi- | Embodi- | Embodi- | Embodi- |
| | ment 6 | ment 7 | ment 8 | ment 9 | ment 10 |
| f | 6.3228 | 6.3218 | 6.2556 | 6.3144 | 6.2386 |
| f1 | 5.0937 | 5.0978 | 5.1258 | 5.0140 | 5.1405 |
| f2 | −12.8720 | −12.3083 | −13.3235 | −12.3532 | −13.3709 |
| f3 | 35.1778 | 27.1748 | 42.2696 | 45.8570 | 35.9075 |
| f4 | −41.9432 | −33.5747 | −44.4868 | −77.9790 | −40.1643 |
| f5 | −42.8440 | −37.9214 | −53.3114 | −36.1296 | −49.8901 |
| f6 | 8.2024 | 8.1560 | 8.2943 | 8.4066 | 8.4039 |
| f7 | −5.3484 | −5.4004 | −5.3848 | −5.2529 | −5.4141 |
| IMG HT | 6.12 | 6.12 | 6.12 | 6.12 | 6.12 |
| Fno | 1.88 | 1.88 | 1.78 | 1.88 | 1.78 |
| FOV | 85.3 | 85.3 | 85.43 | 85.3 | 85.43 |

In an optical imaging system according to an embodiment of the present disclosure, a size may be reduced while realizing high resolution.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An optical imaging system, comprising:
a first lens having positive refractive power;
a second lens having negative refractive power;
a third lens having positive refractive power;
a fourth lens having refractive power;
a fifth lens having refractive power;
a sixth lens having refractive power; and
a seventh lens having refractive power, sequentially disposed from an object side,
wherein the optical imaging system satisfies
$$0 < f 1 / f 3 < 0 \text{.4} ,$$
$$0.5 < TTL / ( 2 \times IMG HT ) < 0.58 , and$$
$$85.3 ° \times ( 6.12 / 6.3228 ) \leq FOV \times ( IMG HT / f ) \leq 88.1 ° \times ( 6.12 / 5.9978 ) ,$$
where f1 is a focal length of the first lens, f3 is a focal length of the third lens, TTL is a distance on an optical axis from an object-side surface of the first lens to an imaging plane, IMG HT is half a diagonal length of the imaging plane, FOV is a field of view of the optical imaging system, and f is a total focal length of the optical imaging system.

2. The optical imaging system of claim 1, satisfying any one or any combination of any two or more of 25<v1−v2<45, 25<v1−v4<45, and 15<v1−v6<25,
where v1 is an Abbe number of the first lens, v2 is an Abbe number of the second lens, v4 is an Abbe number of the fourth lens, and v6 is an Abbe number of the sixth lens.

3. The optical imaging system of claim 1, satisfying 0<f1/f<1.4.

4. The optical imaging system of claim 1, satisfying −10<f2/f<0,
where f2 is a focal length of the second lens.

5. The optical imaging system of claim 1, satisfying −0.6<f1/f2<0,
where f2 is a focal length of the second lens.

6. The optical imaging system of claim 1, satisfying 0<f3/f<10.

7. The optical imaging system of claim 1, satisfying −13<f4/f<0,
where f4 is a focal length of the fourth lens.

8. The optical imaging system of claim 1, satisfying −15<f5/f<0,
where f5 is a focal length of the fifth lens.

9. The optical imaging system of claim 1, satisfying 0<f6/f<1.5,
where f6 is a focal length of the sixth lens.

10. The optical imaging system of claim 1, satisfying −0.95<f7/f<0,
where f7 is a focal length of the seventh lens.

11. The optical imaging system of claim 1, satisfying 1.0<TTL/f<1.3 and 0.15<BFL/f<0.3,
where BFL is a distance along the optical axis from an image-side surface of the seventh lens to the imaging plane.

12. The optical imaging system of claim 1, satisfying 0<D1/f<0.1,
where D1 is a distance along the optical axis from an image-side surface of the first lens to an object-side surface of the second lens.

13. The optical imaging system of claim 1, satisfying
1<Fno×TTL/(2×IMG HT))<1.1,
where Fno is an F number of the optical imaging system.

14. The optical imaging system of claim 1, wherein two or more of the first to seventh lenses have a refractive index greater than 1.6 and negative refractive power.

15. The optical imaging system of claim 1, wherein refractive indices of the fourth lens and the fifth lens are greater than 1.6 and less than 1.7, and
wherein the fourth lens and the fifth lens each have negative refractive power.

16. The optical imaging system of claim 15, wherein among the first to seventh lenses,
an absolute value of a focal length of one of the fourth lens and the fifth lens is the greatest.
